(19) United States
(12) Patent Application Publication
(10) Pub. No.: US 2025/0126493 A1
(43) Pub. Date: Apr. 17, 2025

(54) COMMUNICATION METHOD, COMMUNICATION APPARATUS, AND SYSTEM

(71) Applicant: HUAWEI TECHNOLOGIES CO., LTD., Shenzhen (CN)

(72) Inventors: Yunfei QIAO, Hangzhou (CN); Gongzheng ZHANG, Hangzhou (CN); Jian WANG, Hangzhou (CN); Rong LI, Boulogne Billancourt (FR)

(21) Appl. No.: 18/990,267

(22) Filed: Dec. 20, 2024

Related U.S. Application Data
(63) Continuation of application No. PCT/CN2023/089586, filed on Apr. 20, 2023.

(30) Foreign Application Priority Data
Jun. 24, 2022 (CN) 202210725738.9

(51) Int. Cl. H04W 24/02; H04L 41/16

(52) U.S. Cl. CPC H04W 24/02; H04L 41/16

(57) ABSTRACT

A method includes: A communication apparatus receives information about an artificial intelligence (AI) connection, where the information about the AI connection includes at least one of the following configured for the AI connection: a model, a dataset, and a computing resource; and the communication apparatus sets up the AI connection to an AI node based on the information about the AI connection. The communication apparatus sets up the AI connection to the AI node based on the information about the AI connection including at least one of the model, the dataset, and the computing resource, so that AI-related signaling can be transmitted between the communication apparatus and the AI node based on the AI connection, and an AI-related operation is performed, to implement integration of AI and a wireless network.

### CROSS-REFERENCE TO RELATED APPLICATIONS

This application is a continuation of International Application No. PCT/CN2023/089586, filed on Apr. 20, 2023, which claims priority to Chinese Patent Application No.202210725738.9, filed on Jun. 24, 2022, the disclosures of the aforementioned applications are hereby incorporated by reference in their entireties.

### TECHNICAL FIELD

This disclosure relates to the field of wireless communication, specifically, to wireless communication technologies to which intelligent networks are applied, and in particular, to a communication method, a communication apparatus, and a system.

### BACKGROUND

To cope with the future vision of bringing the benefits of intelligence to all industries, intelligence will further evolve at a level of a wireless network architecture. Artificial intelligence (AI) will be further integrated with a wireless network deeply to achieve endogenous network intelligence and terminal intelligence, thereby meeting some new possible requirements and scenarios. How to integrate AI and a wireless network is an urgent issue to be resolved.

### SUMMARY

One or more embodiments of the present disclosure provide a communication method, a communication apparatus, and a system. An AI connection between a communication apparatus and an AI node is set up, so that a communication apparatus in a wireless network can be used to execute an AI task.

According to a first aspect, a communication method is provided. In some embodiments, the method may be performed by a communication apparatus. The communication apparatus may be a communication device (such as a terminal device or a network device), or may be a chip or a circuit used in the communication device. For ease of description, the following uses a communication apparatus as an example for description.

In some embodiments, the method may include: The communication apparatus receives information about an AI connection, and the communication apparatus sets up the AI connection to an AI node based on the information about the AI connection.

Optionally, the information about the AI connection includes at least one of the following configured for the AI connection: a model, a dataset, and a computing resource.

According to a second aspect, a communication method is provided. The method may be performed by a communication apparatus. The communication apparatus may be a communication device (such as a terminal device or a network device), or may be a chip or a circuit used in the communication device. For ease of description, the following uses a communication apparatus as an example for description.

In some embodiments, the method may include: A communication apparatus receives information about an AI connection, where the information about the AI connection includes at least one of the following configured for the AI connection: a model, a dataset, and a computing resource; and the communication apparatus sets up the AI connection to an AI node based on the information about the AI connection.

Based on the technical solution of the first aspect or the second aspect, in some embodiments, the communication apparatus may receive the information about the AI connection, and set up the AI connection to the AI node based on the information about the AI connection. In this way, the AI node and the communication apparatus may communicate with each other through the AI connection, for example, send and/or receive an AI task, or send and/or receive a processing result of the AI task, to implement convergence of AI and a wireless network, and implement execution of an AI-related task by a communication apparatus in the wireless network.

In some embodiments, the method further includes: The communication apparatus sends an AI message to the AI node through the AI connection, and/or the communication apparatus receives an AI message from the AI node through the AI connection, where the AI message indicates at least one of the following information: an encryption mode used for the AI message, a compression mode used for the AI message, a message type of the AI message, control information or data carried in the AI message, a verification code for performing integrity verification on the AI message, or content carried in the AI message.

In some embodiments, the method further includes: The communication apparatus receives information about an updated AI connection through the AI connection.

Based on the foregoing technical solution, in some embodiments, the information about the AI connection may be dynamically updated, and the communication apparatus may receive the information about the updated AI connection. In this way, the information about the AI connection may be dynamically updated based on a communication status.

In some embodiments, the method further includes at least one of the following: If the information about the AI connection includes the model, the communication apparatus processes the model; if the information about the AI connection includes the dataset, the communication apparatus performs measurement based on the dataset; and if the information about the AI connection includes the computing resource, the communication apparatus uses the computing resource to execute an AI task.

In some embodiments, the method further includes: The communication apparatus publishes a first AI task to the AI node through the AI connection; and/or the communication apparatus receives a second AI task from the AI node through the AI connection.

Based on the foregoing technical solution, in some embodiments, the communication apparatus may publish an Al task to the AI node through the AI connection between the communication apparatus and the AI node, or may receive a task published by the AI node.

In some embodiments, that the communication apparatus publishes a first AI task to the AI node through the AI connection includes: The communication apparatus publishes the first AI task to the AI node through the AI connection, to publish the first AI task to another communication apparatus via the AI node.

For example, the another communication apparatus may be another AI node or a network device, or may be a terminal device, in accordance with some embodiments.

Based on the foregoing technical solution, the communication apparatus may publish an Al task to another communication apparatus via the AI node through the AI connection between the communication apparatus and the AI node. In this way, the technical solution can be applied to more scenarios. For example, when the AI node cannot execute the AI task, the AI node may publish the AI task to another communication apparatus. For another example, if the communication apparatus cannot directly communicate with another communication apparatus, the AI node may also publish the AI task to the another communication apparatus.

In some embodiments, the method further includes: when a preset condition is met, the communication apparatus sends a processing result of the second AI task.

Based on the foregoing technical solution, in some embodiments, the communication apparatus may report the processing result of the task when the preset condition is met.

In some embodiments, the second AI task includes indication information of the preset condition.

In some embodiments, the method further includes: The communication apparatus sends a request message to the AI node, where the request message is for requesting to set up the Al connection; or the communication apparatus receives indication information from the AI node, where the indication information is for triggering the communication apparatus to set up the AI connection to the AI node.

Based on the foregoing technical solution, in some embodiments, before the communication apparatus and the AI node set up the AI connection, the AI connection to the AI node may be set up by the communication apparatus by initiating a request, or the AI connection to the communication apparatus may be set up by the AI node through triggering. In this way, the communication apparatus or the AI node may set up the AI connection when needing to perform a related operation through the AI connection, for example, publishing an AI task, to avoid a resource waste caused by not using the AI connection after the AI connection is set up.

In some embodiments, the request message further includes indication information of a request type, the request type indicates a purpose of requesting to set up the AI connection, and the dataset is determined based on the request type.

In some embodiments, the information about the AI connection further includes at least one of the following: an identifier of the AI connection and information about a radio bearer associated with the AI connection.

In some embodiments, the AI node is deployed on any one of the following: a network device and a terminal device.

In some embodiments, the method further includes: The communication apparatus sends an AI capability of the communication apparatus.

For example, the communication apparatus sends the AI capability of the communication apparatus to a core network, in accordance with some embodiments.

In some embodiments, the AI capability of the communication apparatus includes at least one of the following: an AI task type supported by the communication apparatus, a hardware capability of the communication apparatus, a computing capability of the communication apparatus, and a priority of the communication apparatus.

According to a third aspect, a communication method is provided. The method may be performed by an AI node. The AI node may be a communication device, or may be a chip or a circuit used in the communication device. For ease of description, the following uses an AI node as an example for description.

In some embodiments, the method may include: The AI node sends information about an AI connection; and the AI node sets up the AI connection to a communication apparatus based on the information about the AI connection.

Optionally, the information about the AI connection includes at least one of the following configured for the AI connection: a model, a dataset, and a computing resource.

According to a fourth aspect, a communication method is provided. The method may be performed by an AI node. The AI node may be a communication device, or may be a chip or a circuit used in the communication device. For ease of description, the following uses an AI node as an example for description.

In some embodiments, the method may include: An AI node sends information about an AI connection, where the information about the AI connection includes at least one of the following configured for the AI connection: a model, a dataset, and a computing resource; and the AI node sets up the AI connection to a communication apparatus based on the information about the AI connection.

In some embodiments, the method further includes: The AI node sends an AI message to the communication apparatus through the AI connection, and/or the AI node receives an AI message from the communication apparatus through the AI connection, where the AI message indicates at least one of the following information: an encryption mode used for the AI message, a compression mode used for the AI message, a message type of the AI message, control information or data carried in the AI message, a verification code for performing integrity verification on the AI message, or content carried in the AI message.

In some embodiments, the method further includes: The AI node sends information about an updated AI connection to the communication apparatus through the AI connection.

In some embodiments, the method further includes at least one of the following: If the information about the AI connection includes the model, the AI node processes, based on the model, data sent by the communication apparatus; if the information about the AI connection includes the dataset, the AI node manages the dataset; and if the information about the AI connection includes the computing resource, the AI node uses the computing resource to execute an AI task.

In some embodiments, the method further includes: The AI node determines the information about the AI connection based on an AI capability of the communication apparatus.

In some embodiments, the method further includes: The AI node receives, through an AI connection between the AI node and each of at least one communication apparatus, a first AI task published by the at least one communication apparatus; and/or the AI node publishes a second AI task to the at least one communication apparatus through the AI connection between the AI node and each of the at least one communication apparatus, where the at least one communication apparatus includes the communication apparatus.

In some embodiments, that the AI node publishes a second AI task to the communication apparatus through the AI connection between the AI node and the communication apparatus includes: The AI node publishes the second AI task to the communication apparatus through the AI connection between the AI node and the communication apparatus, to publish the second AI task to another communication apparatus via the communication apparatus.

In some embodiments, the method further includes: When a preset condition is met, the AI node sends a processing result of the first AI task to the at least one communication apparatus through the AI connection between the AI node and each of the at least one communication apparatus.

In some embodiments, the first AI task includes indication information of the preset condition.

In some embodiments, the method further includes: The AI node receives a request message from the communication apparatus, where the request message is for requesting to set up the AI connection; or the AI node sends indication information to the communication apparatus, where the indication information is for triggering the communication apparatus to set up the AI connection to the AI node.

In some embodiments, the request message further includes indication information of a request type, the request type indicates a purpose of requesting to set up the AI connection, and the dataset is determined based on the request type.

In some embodiments, the information about the AI connection further includes at least one of the following: an identifier of the AI connection and information about a radio bearer associated with the AI connection.

In some embodiments, the AI node includes a first AI node and a second AI node, and the first AI node and/or the second AI node meet any one of the following: the first AI node is configured to transmit signaling, and the second AI node is configured to process an AI task; the second AI node is configured to process an AI operation indicated by the first AI node; the first AI node is configured to process a first-type AI task, the second AI node is configured to process a second-type AI task, and the first-type AI task is not completely the same as the second-type AI task; and the second AI node is configured to store and/or send a processing result of the AI task.

In some embodiments, the method further includes: The first AI node sends notification information to the second AI node, where the notification information is for notifying the second AI node of at least one of the following: executing the AI task, saving the processing result of the AI task, and sending the processing result of the AI task.

In some embodiments, the AI node is deployed on any one of the following: a network device and a terminal device.

In some embodiments, the AI node is deployed on a network device, and the method further includes: The network device determines, based on at least one of the following: the model, the dataset, and the computing resource, information about a radio bearer associated with the AI connection.

For beneficial effects of the third aspect or the fourth aspect and the possible designs, refer to the related descriptions of the first aspect or the second aspect. Details are not described herein again.

According to a fifth aspect, a communication method is provided. The method may be performed by a communication apparatus. The communication apparatus may be a communication device (such as a terminal device or a network device), or may be a chip or a circuit used in the communication device. For ease of description, the following uses a communication apparatus as an example for description.

In some embodiments, the method may include: The communication apparatus publishes an AI task to an AI node through an AI connection between the communication apparatus and the AI node; and the communication apparatus receives a processing result of the AI task.

Based on the foregoing technical solution, in some embodiments, the communication apparatus may publish the AI task to the AI node through the AI connection between the communication apparatus and the AI node, so that convergence of AI and a wireless network can be implemented, and an apparatus (for example, the AI node or another communication apparatus) in the wireless network executes the AI task.

In some embodiments, that the communication apparatus publishes an AI task to an AI node through an AI connection between the communication apparatus and the AI node includes: The communication apparatus publishes the AI task to the AI node through the AI connection, to publish the AI task to another communication apparatus via the AI node.

Based on the foregoing technical solution, in some embodiments, the communication apparatus may publish an AI task to another communication apparatus via the AI node through the AI connection between the communication apparatus and the AI node. In this way, the technical solution can be applied to more scenarios. For example, when the AI node cannot execute the AI task, the AI node may publish the AI task to another communication apparatus. For another example, if the communication apparatus cannot directly communicate with another communication apparatus, the AI node may also publish the AI task to the another communication apparatus.

In some embodiments, the method further includes: The communication apparatus sends a request message to the AI node, where the request message is for requesting to set up the AI connection; or the communication apparatus receives indication information from the AI node, where the indication information is for triggering the communication apparatus to set up the AI connection to the AI node.

In some embodiments, the AI node is deployed on any one of the following: a network device and a terminal device.

According to a sixth aspect, a communication method is provided. The method may be performed by an AI node. The AI node may be a communication device, or may be a chip or a circuit used in the communication device. For ease of description, the following uses an AI node as an example for description.

In some embodiments, the method may include: An AI node receives, through an AI connection between the AI node and each of at least one communication apparatus, an AI task published by the at least one communication apparatus; and the AI node executes the AI task, or the AI node publishes the AI task to another communication apparatus.

In some embodiments, the at least one communication apparatus includes a first communication apparatus, and the method further includes: The AI node sends a processing result of the AI task to the first communication apparatus through an AI connection between the AI node and the first communication apparatus.

In some embodiments, that the AI node sends a processing result of the AI task to the first communication apparatus through an AI connection between the AI node and the first communication apparatus includes: When the preset condition is met, the AI node sends the processing result of the AI task to the first communication apparatus through the AI connection between the AI node and the first communication apparatus.

In some embodiments, the AI task includes indication information of the preset condition.

In some embodiments, the AI node publishes the AI task to another communication apparatus, and the method further includes: The AI node receives a processing result of the AI task sent by the another communication apparatus.

In some embodiments, the at least one communication apparatus includes a second communication apparatus, and the method further includes: The AI node receives a request message from the second communication apparatus, where the request message is for requesting to set up an AI connection between the AI node and the second communication apparatus; or the AI node sends indication information to the second communication apparatus, where the indication information is for triggering the second communication apparatus to set up the AI connection between the AI node and the second communication apparatus to the AI node.

In some embodiments, the AI node is deployed on any one of the following: a network device and a terminal device.

For beneficial effects of the sixth aspect and the possible designs, refer to the related descriptions of the fifth aspect. Details are not described herein again.

According to a seventh aspect, a communication method is provided. The method may be performed by a communication apparatus. The communication apparatus may be a communication device (such as a terminal device or a network device), or may be a chip or a circuit used in the communication device. For ease of description, the following uses a communication apparatus as an example for description.

In some embodiments, the method may include: The communication apparatus receives an AI task from an AI node through an AI connection between the communication apparatus and the AI node; and the communication apparatus executes the AI task, or the communication apparatus publishes the AI task to another communication apparatus.

Based on the foregoing technical solution, the AI node may publish the AI task to the communication apparatus or the another communication apparatus through the AI connection between the AI node and the communication apparatus. The AI node may publish the AI task to the communication apparatus, and the communication apparatus processes the AI task. In this way, the AI task can be completed by using an idle computing resource (for example, a computing power of the communication apparatus), thereby reducing load and energy consumption of an AI network.

In some embodiments, the method further includes: The communication apparatus sends a processing result of the AI task to the AI node through the AI connection.

In some embodiments, that the communication apparatus sends a processing result of the AI task to the AI node through the AI connection includes: When a preset condition is met, the communication apparatus sends the processing result of the AI task to the AI node through the AI connection.

In some embodiments, the AI task includes indication information of the preset condition.

In some embodiments, the communication apparatus publishes the AI task to another communication apparatus, and the method further includes: The communication apparatus receives a processing result of the AI task sent by the another communication apparatus.

In some embodiments, the method further includes: The communication apparatus sends a request message to the AI node, where the request message is for requesting to set up the AI connection; or the communication apparatus receives indication information from the AI node, where the indication information is for triggering the communication apparatus to set up the AI connection to the AI node.

In some embodiments, the AI node is deployed on any one of the following: a network device and a terminal device.

According to an eighth aspect, a communication method is provided. The method may be performed by an AI node. The AI node may be a communication device, or may be a chip or a circuit used in the communication device. For ease of description, the following uses an AI node as an example for description.

In some embodiments, the method may include: The AI node publishes, through an AI connection between the AI node and each of at least one communication apparatus, an AI task to the at least one communication apparatus; and the AI node receives a processing result of the AI task.

In some embodiments, the at least one communication apparatus includes a first communication apparatus, and the AI node publishes an AI task to the first communication apparatus through an AI connection between the AI node and the first communication apparatus, including: The AI node publishes the AI task to the first communication apparatus, to publish the AI task to another communication apparatus via the first communication apparatus.

In some embodiments, the at least one communication apparatus includes a second communication apparatus, and the method further includes: The AI node receives a request message from the second communication apparatus, where the request message is for requesting to set up an AI connection between the AI node and the second communication apparatus; or the AI node sends indication information to the second communication apparatus, where the indication information is for triggering the second communication apparatus to set up the AI connection between the AI node and the second communication apparatus to the AI node.

In some embodiments, the AI node is deployed on any one of the following: a network device and a terminal device.

For beneficial effects of the eighth aspect and the possible designs, refer to the related descriptions of the seventh aspect. Details are not described herein again.

According to a ninth aspect, a communication apparatus is provided. The apparatus is configured to perform the method according to any one of the first aspect to the eighth aspect. Specifically, the apparatus may include a unit and/or a module configured to perform the method according to any embodiment of any one of the first aspect to the eighth aspect, for example, a processing unit and/or a communication unit.

In an embodiment, the apparatus is a communication device (for example, a terminal device, an AI node, or a network device). When the apparatus is a communication device, the communication unit may be a transceiver or an input/output interface; and the processing unit may be at least one processor. Optionally, the transceiver may be a transceiver circuit. Optionally, the input/output interface may be an input/output circuit.

In some embodiments, the apparatus is a chip, a chip system, or a circuit used in a communication device. When the apparatus is a chip, a chip system, or a circuit used in a terminal device, the communication unit may be an input/output interface, an interface circuit, an output circuit, an input circuit, a pin, a related circuit, or the like on the chip, the chip system, or the circuit, and the processing unit may be at least one processor, processing circuit, logic circuit, or the like.

According to a tenth aspect, a communication apparatus is provided. The apparatus includes: a memory; configured to store a program; and at least one processor, configured to execute a computer program or instructions stored in the memory, to perform the method according to any embodiment of the first aspect to the eighth aspect.

In some embodiments, the apparatus is a communication device (for example, a terminal device, an AI node, or a network device).

In some embodiments, the apparatus is a chip, a chip system, or a circuit used in a communication device.

According to an eleventh aspect, this disclosure provides a processor, configured to perform the methods provided in the foregoing aspects.

Operations such as sending and obtaining/receiving related to the processor may be understood as operations such as output and input of the processor, or sending and receiving operations performed by a radio frequency circuit and an antenna, unless otherwise specified, or provided that the operations do not contradict actual functions or internal logic of the operations in related descriptions.

According to a twelfth aspect, a computer-readable storage medium is provided. The computer-readable medium stores program code to be executed by a device, and the program code includes the method according to any embodiment of the first aspect to the eighth aspect.

According to a thirteenth aspect, a computer program product including instructions is provided. When the computer program product runs on a computer, the computer is enabled to perform the method according to any embodiment of the first aspect to the eighth aspect.

According to a fourteenth aspect, a chip is provided. The chip includes a processor and a communication interface. The processor reads, through the communication interface, instructions stored in a memory, to perform the method according to any embodiment of the first aspect to the eighth aspect.

Optionally, in some embodiments, the chip further includes the memory. The memory stores a computer program or the instructions. The processor is configured to execute the computer program or the instructions stored in the memory. When the computer program or the instructions are executed, the processor is configured to perform the method according to any embodiment of the first aspect to the eighth aspect.

According to a fifteenth aspect, a communication system is provided, and includes the communication apparatus and the AI node that are described above.

### BRIEF DESCRIPTION OF DRAWINGS

FIG. 1 is a schematic of a wireless communication system 100 applicable to an embodiment of this disclosure;

FIG. 2 is a schematic of a communication system according to an embodiment of this disclosure;

FIG. 3 is a schematic of a communication system according to another embodiment of this disclosure;

FIG. 4 is a schematic of a communication method 400 according to an embodiment of this disclosure;

FIG. 5 is a schematic of a protocol stack for communication between a terminal device and an AI node #1;

FIG. 6 is a schematic of an information element format of an AI message;

FIG. 7 is a schematic of a protocol stack for communication between a UE and an AI node #2;

FIG. 8 is a schematic flowchart of a communication method 800 according to an embodiment of this disclosure;

FIG. 9 is a schematic of a radio bearer;

FIG. 10 is a schematic flowchart of a communication method 1000 according to another embodiment of this disclosure;

FIG. 11 is a schematic flowchart of a communication method 1100 according to another embodiment of this disclosure;

FIG. 12 is a schematic flowchart of a communication method 1200 according to another embodiment of this disclosure;

FIG. 13 is a block schematic of a communication apparatus 1300 according to an embodiment of this disclosure;

FIG. 14 is a block schematic of a communication apparatus 1400 according to an embodiment of this disclosure; and

FIG. 15 is a block schematic of a chip system 1500 according to an embodiment of this disclosure.

### DETAILED DESCRIPTION

The following describes the technical solutions of embodiments in this disclosure with reference to accompanying drawings.

The technical solutions provided in this disclosure may be applied to various communication systems, for example, a 5th generation (5G) or new radio (NR) system, a long term evolution (LTE) system, an LTE frequency division duplex (FDD) system, and an LTE time division duplex (TDD) system. The technical solutions provided in this disclosure are also applicable to a future communication system, for example, a 6th generation mobile communication system. The technical solutions provided in this disclosure may be further applied to device-to-device (D2D) communication, vehicle-to-everything (V2X) communication, machine-to-machine (M2M) communication, machine type communication (MTC), an internet of things (IoT) communication system, or another communication system.

A terminal device in embodiments of this disclosure includes various devices having a wireless communication function, and the terminal device may be configured to connect to a person, an object, a machine, and the like. The terminal device may be widely used in various scenarios, for example, cellular communication, D2D, V2X, peer to peer (P2P), M2M, MTC, IoT, virtual reality (VR), augmented reality (AR), industrial control, autonomous driving, telemedicine, smart grid, smart furniture, smart office, smart wearable, smart transportation, smart city drone, robot, remote sensing, passive sensing, positioning, navigation and tracking, and autonomous delivery. The terminal device may be a terminal in any one of the foregoing scenarios, for example, an MTC terminal or an IoT terminal. The terminal device may be a user equipment (UE) in a 3rd generation partnership project (3GPP) standard, a terminal, a fixed device, a mobile station device or a mobile device, a subscriber unit, a handheld device, a vehicle-mounted device, a wearable device, a cellular phone, a smartphone, a SIP phone, a wireless data card, a personal digital assistant (PDA), a computer, a tablet computer, a notebook computer, a wireless modem, a handset, a laptop computer, a computer having a wireless transceiver function, a smart book, a vehicle, a satellite, a global positioning system (GPS) device, a target tracking device, a flight device (for example, an uncrewed aerial vehicle, a helicopter, a multi-helicopter, a four-helicopter, or an airplane), a ship, a remote control device, a smart home device, or an industrial device, may be an apparatus built in the foregoing device (for example, a communication module, a modem, or a chip in the foregoing device), or may be another processing device connected to the wireless modem. For ease of description, an example in which the terminal device is a terminal or a UE is used below for description.

It should be understood that, in some scenarios, the UE may further serve as a base station. For example, the UE may act as a scheduling entity that provides a sidelink signal between UEs in a V2X scenario, a D2D scenario, a P2P scenario, or the like.

In embodiments of this disclosure, an apparatus configured to implement a function of the terminal device may be the terminal device, or may be an apparatus that can support the terminal device in implementing the function, for example, a chip system or a chip. The apparatus may be installed in the terminal device. In embodiments of this disclosure, the chip system may include a chip, or may include a chip and another discrete component.

A network device in embodiments of this disclosure may be a device configured to communicate with the terminal device. The network device may also be referred to as an access network device or a radio access network device. For example, the network device may be a base station. The network device in embodiments of this disclosure may be a radio access network (RAN) node (or device) that enables the terminal device to access a wireless network. The base station may cover various names in the following in a broad sense, or may alternatively be the following names, for example, a NodeB, an evolved NodeB (eNB), a next generation NodeB (gNB), a relay station, an access point, a transmission reception point (TRP), a transmission point (TP), a master station, a secondary station, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a radio frequency head (RRH), a central unit (CU), a distributed unit (DU), a positioning node, and the like. The base station may be a macro base station, a micro base station, a relay node, a donor node, or the like, or a combination thereof. The base station may alternatively be a communication module, a modem, or a chip that is disposed in the foregoing device or apparatus. The base station may alternatively be a mobile switching center, a device that bears a base station function in D2D, V2X, and M2M communication, a network side device in a 6G network, a device that bears a base station function in a future communication system, or the like. The base station may support networks using a same access technology or different access technologies. A specific technology and a specific device form that are used by the network device are not limited in embodiments of this disclosure.

The base station may be fastened or movable. For example, a helicopter or an uncrewed aerial vehicle may be configured as a mobile base station, and one or more cells may move based on a position of the mobile base station. In other examples, a helicopter or an uncrewed aerial vehicle may be configured as a device for communicating with another base station.

The network device and the terminal device may be deployed on land, including an indoor device or an outdoor device, and a handheld device or a vehicle-mounted device; or may be deployed on water; or may be deployed on an airplane, a balloon, and a satellite in the air. Scenarios in which the network device and the terminal device are located are not limited in embodiment of this disclosure.

First, a network architecture applicable to this disclosure is briefly described as follows:

FIG. 1 is a schematic of a wireless communication system 100 applicable to an embodiment of this disclosure. As shown in FIG. 1, the wireless communication system 100 may include at least one network device, for example, a network device 110 shown in FIG. 1. The wireless communication system 100 may further include at least one terminal device, for example, a terminal device 120 and a terminal device 130 shown in FIG. 1. A plurality of antennas may be configured for both the network device and the terminal device, and the network device and the terminal device may communicate with each other by using a multi-antenna technology. The terminal devices may directly communicate with each other.

When the network device communicates with the terminal device, the network device may manage one or more cells, and one cell may have an integer quantity of terminal devices. Optionally, the network device 110 and the terminal device 120 form a single-cell communication system. Without loss of generality, the cell is denoted as a cell #1. The network device 110 may be a network device in the cell #1, or the network device 110 may serve a terminal device (for example, the terminal device 120) in the cell #1.

It should be noted that the cell may be understood as an area within coverage of a radio signal of the network device.

It should be understood that FIG. 1 is merely a simplified schematic of an example for ease of understanding. The wireless communication system 100 may further include another network device or may further include another terminal device, which is not shown in FIG. 1. Embodiments of this disclosure may be applicable to any communication scenario in which a transmitter device communicates with a receiver device.

To cope with the future vision of bring benefits of intelligence to all industries, intelligence will further evolve at a level of a wireless network architecture. Artificial intelligence (AI) will be further integrated with a wireless network deeply to achieve endogenous network intelligence and terminal intelligence, thereby meeting some new possible requirements and scenarios. For example, in a possible scenario, terminal types are diversified, and terminal connections are more flexible and intelligent. The terminal types are diversified. In a supper internet of things (supper IoT) (for example, an internet of things, an internet of vehicles, industry, and medical treatment) scenario and a scenario with massive connections, the terminal connections are more flexible, and terminals have specific AI capabilities. For another example, a possible requirement is the network-inherent intelligence. The network may provide not only a traditional communication connection service but also computing and AI services to better support an inclusive, real-time, and highly secure AI service. These new requirements and new scenarios may bring changes to a wireless network architecture and a communication mode.

Currently, 3GPP introduces AI capabilities by adding a network data analytics function (NWDAF) to a 5G network. Main functions of the NWDAF include: collecting data from another network function (NF) and an application function (AF), collecting data from a network operations and maintenance system (for example, an operation, administration and maintenance (OAM)), and providing a metadata exposure service, a data analytics service, and the like for the NF or the AF. The NWDAF is introduced mainly for automatic and intelligent network operation and maintenance, network performance and service experience optimization, end-to-end service level agreement (SLA) assurance, and the like. An AI model trained by the NWDAF may be applied to network fields such as mobility management, session management, and network automation, and an AI method is used to replace a numerical formula-based method in an original network function. However, the NWDAF is deployed on the core network and is an external AI unit. The NWDAF is not strongly coupled to the communication network, and has limited performance.

Based on possible scenarios and requirements faced by a future wireless network, a quantity of terminal devices and types of the terminal devices in the communication network may also increase rapidly. A large amount of data collected, processed, and generated by the terminal devices may provide a driving force for application of AI technologies. In this background, the following is considered in this disclosure: On one hand, an AI-related task has a high requirement on a computing power, and a load and energy consumption of AI network construction are high. On the other hand, computing powers of many terminal devices in the network may be idle. Therefore, this disclosure proposes to build an endogenous AI function in a communication network, so that the communication network is more closely combined with the AI, and a better AI service is provided.

It should be noted that in this disclosure, “indication” may include a direct indication, an indirect indication, an explicit indication, and an implicit indication. When a piece of indication information is described as indicating A, it may be understood that the indication information carries A, directly indicates A, or indirectly indicates A.

In this disclosure, information indicated by the indication information is referred to as to-be-indicated information. In a specific implementation process, the to-be-indicated information is indicated in a plurality of manners, for example, but not limited to, the following manners: The to-be-indicated information is directly indicated, for example, the to-be-indicated information or an index of the to-be-indicated information is indicated. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of a plurality of pieces of information that is pre-agreed on (for example, stipulated in a protocol), to reduce indication overheads to some extent.

The to-be-indicated information may be sent as a whole, or may be divided into a plurality of pieces of sub-information for separate sending. In addition, sending periodicities and/or sending occasions of these pieces of sub-information may be the same or may be different. A specific sending method is not limited in this disclosure. The sending periodicities and/or the sending occasions of these pieces of sub-information may be predefined, for example, predefined according to a protocol, or may be configured by a transmitter device by sending configuration information to a receiver device. The configuration information may include, for example, but not limited to, one or a combination of at least two of radio resource control signaling, media access control (MAC) layer signaling, and physical layer signaling. The radio resource control signaling includes, for example, radio resource control (RRC) signaling. The MAC layer signaling includes, for example, a MAC control element (MAC CE). The physical layer signaling includes, for example, downlink control information (DCI).

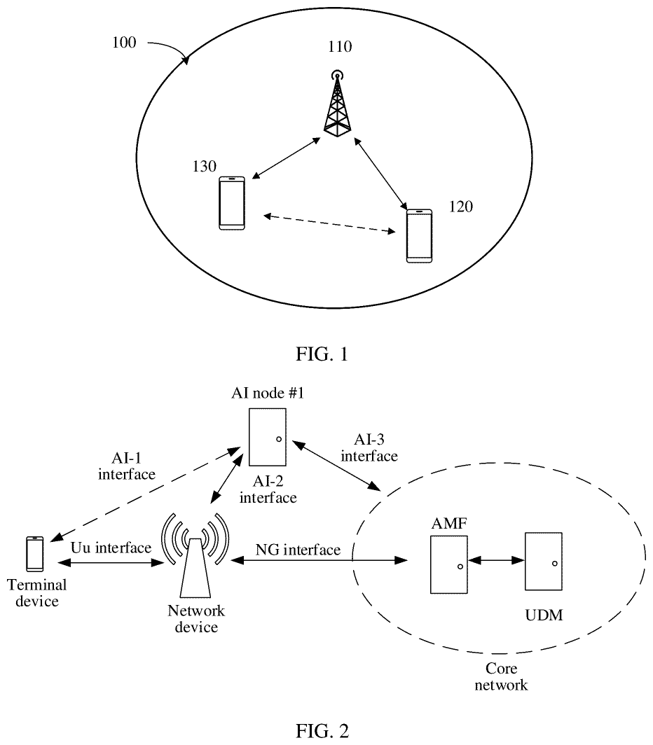

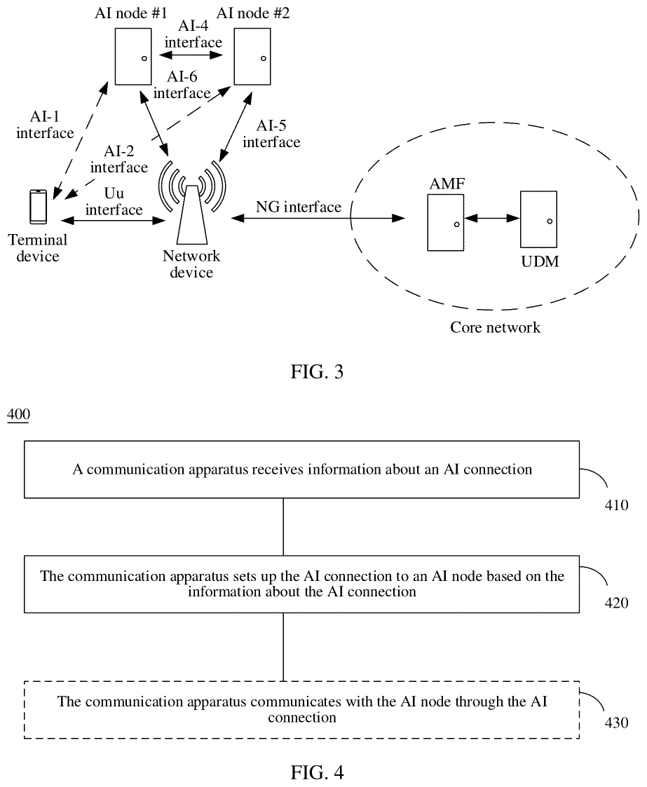

First, the communication system provided in embodiments of this disclosure is described with reference to FIG. 2 and FIG. 3. It should be noted that all interfaces used in the following examples are examples. In this disclosure, another interface with a same function may be used. Use of the interface is not limited in this disclosure.

FIG. 2 is a schematic of a communication system according to an embodiment of this disclosure. As shown in FIG. 2, the communication system may include a terminal device and an AI node #1. The terminal device may communicate with the AI node #1 through an AI-1 interface. In other words, the AI-1 interface may be configured to send and/or receive AI-related signaling. For example, the terminal device may publish an AI task to the AI node #1 through the AI-1 interface. For another example, the AI node #1 may publish an AI task to the terminal device through the AI-1 interface. For another example, the terminal device may send and/or receive a processing result of an AI task to/from the AI node #1 through the AI-1 interface. For another example, the AI node #1 may send and/or receive a processing result of an AI task to/from the terminal device through the AI-1 interface. For another example, the terminal device may request, through the AI-1 interface, the AI node #1 to publish an AI task to another apparatus (for example, another AI node, another terminal device, or a network device). For another example, the AI node #1 may request, through the AI-1 interface, the terminal device to publish an AI task to another apparatus (for example, another AI node, another terminal device, or a network device).

In this disclosure, the AI task represents a task related to AI. In an example, the AI task may include, for example, a model failure test, a model performance test, a model training test, and data collection.

In this disclosure, that the terminal device communicates with the AI node #1 through the AI-1 interface may alternatively be that the terminal device communicates with the AI node #1 through an AI connection. The AI connection indicates a connection between the terminal device and the AI node #1. The terminal device and the AI node #1 may transmit, through the AI connection, AI-related signaling and perform an AI-related operation. It may be understood that the AI connection represents a connection relationship between the terminal device and the AI node #1, and is a logical concept rather than a physical entity. Details are not described below.

The AI-1 interface may be a logical interface. The AI-1 interface may be implemented by a connection between the terminal device and a network device and a connection between the network device and the AI node #1. For example, the terminal device sends a message to the AI node #1 through the AI-1 interface, which may include: The terminal device sends the message to the network device, and the network device forwards the message to the AI node #1. In other words, the network device may be similar to a relay device between the terminal device and the AI node #1.

Optionally, the AI node #1 manages the AI-1 interface. For example, the AI node #1 is responsible for establishing, maintaining, and releasing the AI-1 interface. For another example, the AI node #1 is responsible for configuring, updating, and releasing a resource that is for the AI-1 interface.

Optionally, the AI node #1 is deployed on any one of the following: the network device and the terminal device. It may be understood that the AI node #1 may alternatively be independently deployed, that is, deployed in a location outside the network device and the terminal device, for example, a location close to the network device, or a location close to the terminal device. This is not limited. In addition, a quantity of AI nodes #1 is not limited.

Optionally, the communication system may further include a network device. The network device may communicate with the terminal device, and the network device may also communicate with the AI node #1. As shown in FIG. 3, the network device may communicate with the terminal device through a UE-universal terrestrial radio access network (Uu) interface, and the AI node #1 may communicate with the network device through an AI-2 interface.

Optionally, the communication system further includes a core network. The core network may communicate with the network device, and the core network may also communicate with the AI node #1. As shown in FIG. 3, the core network may communicate with the network device through a next generation (NG) interface, and the core network may communicate with the AI node #1 through an AI-3 interface.

The core network may be an apparatus and/or a software system deployed in a wireless network. The core network may include one or more core network nodes, to provide core network functions such as UE connection management, mobility management, and policy management. The core network may further provide a user plane gateway function to an external network, for example, an internet. The core network node may be a next generation (for example, 6G or a later version) core network node or a core network node of seom approaches (for example, 5G, 4^{th} generation (4G), 3^{rd} generation (3G), or 2^{nd} generation (2G)). In a possible design, the core network may include network elements such as an access and mobility management function (AMF) network element and a unified data management (UDM) network element. The core network may further include one or more network nodes in a public switched telephone network (PSTN), a packet data network, an optical network, or an internet protocol (IP) network, a wide area network (WAN), a local area network (LAN), a wireless local area network (WLAN), a wired network, a wireless network, a metropolitan area network, and other networks, to help communication between the terminal device and/or the network device.

In systems using different radio access technologies, names of devices having the core network function and network functions included in the devices may be different. For example, a 4G core network is generally referred to as an evolved packet core (EPC), and a 5G core network is generally referred to as a 5G core network (5GC or 5GCN).

Optionally, the core network (for example, the UDM) stores an AI capability of the terminal device. For example, the core network stores subscription information of the terminal device, and the subscription information of the terminal device includes the AI capability of the terminal device. If the AI node #1 needs to query the AI capability of the terminal device, the AI node #1 may query the AI capability of the terminal device from the core network through the AI-3 interface. The AI capability of the terminal device may also be referred to as an AI-related parameter of the terminal device. The AI capability of the terminal device is used for description below.

The AI capability of the terminal device may include, for example, at least one of the following: a priority of the terminal device, a maximum computing power supported by the terminal device, a hardware capability of the terminal device, and an AI task type supported by the terminal device. In an example, the priority of the terminal device may be determined based on a historical response status of the terminal device. For example, if the terminal device participates in coordinative processing of the AI task for a larger quantity of times, the priority of the terminal device is higher; or if the terminal device participates in coordinative processing of the AI task for a smaller quantity of times, the priority of the terminal device is lower. In another example, the priority of the terminal device may be determined based on the capability of the terminal device (for example, the supported maximum computing power or the hardware capability of the terminal device). For example, if the capability of the terminal device is stronger, the priority of the terminal device is higher; or if the capability of the terminal device is weaker, the priority of the terminal device is lower.

It may be understood that the foregoing is an example for description. This is not limited. For example, the AI capability of the terminal device may further include a security requirement of the terminal device and the like.

It may be further understood that, that the core network (for example, the UDM) stores the AI capability of the terminal device is an example for description. For example, an AI node (for example, the AI node #1) stores the AI capability of the terminal device. If the AI node #1 needs to query the AI capability of the terminal device, the AI node #1 may directly locally determine the AI capability of the terminal device, or obtain the AI capability of the terminal device from another AI node.

FIG. 3 is a schematic of a communication system according to another embodiment of this disclosure. Compared with the system shown in FIG. 2, the communication system shown in FIG. 3 further includes an AI node #2. FIG. 3 is merely an example. There are not limited to two AI nodes, and there may be a plurality of AI nodes. The AI node #2 may communicate with another device in the communication system. For example, the AI node #2 may communicate with the terminal device through an AI-6 interface, the AI node #2 may communicate with the AI node #1 through an AI-4 interface, and the AI node #2 may communicate with the network device through an AI-5 interface. Optionally, the AI node #2 is deployed on any one of the following: the network device and the terminal device. It may be understood that the AI node #2 may alternatively be independently deployed, that is, deployed in a location outside the network device and the terminal device, for example, a location close to the network device, or a location close to the terminal device. This is not limited. In addition, a quantity of AI nodes #2 is not limited.

In this disclosure, that the terminal device communicates with the AI node #2 through the AI-6 interface may alternatively be that the terminal device communicates with the AI node #2 through an AI connection. The AI connection indicates an AI connection between the terminal device and the AI node #2. The terminal device and the AI node #2 may transmit, through the AI connection, AI-related signaling and perform an AI-related operation.

The AI-6 interface may be a logical interface. The AI-6 interface may be implemented by a connection between the terminal device and a network device and a connection between the network device and the AI node #2. For example, the terminal device sends a message to the AI node #2 through the AI-6 interface, which may include: The terminal device sends the message to the network device, and the network device forwards the message to the AI node #2. In other words, the network device may be similar to a relay device between the terminal device and the AI node #2.

Optionally, the AI node #1 is responsible for managing the AI-6 interface. For example, the AI node #1 is responsible for establishing, maintaining, and releasing the AI-6 interface. For another example, the AI node #1 is responsible for a resource that is for the AI-6 interface, for example, configuring, updating, and releasing the resource that is for the AI-6 interface.

The AI node #1 and the AI node #2 may be AI nodes responsible for different functions.

In a first possible design, the AI node #1 is responsible for signaling transmission, and the AI node #2 is responsible for performing a processing operation. That the AI node #2 is responsible for performing a processing operation may include, for example, at least one of the following: The AI node #2 processes an AI task, the AI node #2 maintains a processing result of the AI task, the AI node #2 maintains an AI-related dataset, and the AI node #2 maintains an AI-related model.

In a second possible design, the AI node #2 is responsible for performing various operations indicated by the AI node #1. For example, the AI node #1 indicates the AI node #2 to process an AI task, and the AI node #2 processes the corresponding AI task after receiving an indication from the AI node #1. Optionally, the AI node #2 is further configured to send a processing result of the AI task to the terminal device (for example, through the AI-6 interface).

In a third possible design, the AI node #1 is responsible for processing a first-type AI task, the AI node #2 is responsible for processing a second-type AI task, and the first-type AI task is not completely the same as the second-type AI task. In an example, overheads generated for processing the first-type AI task are less than overheads generated for processing the second-type AI task. In this design, the AI node #1 and the AI node #2 are equivalent to two different AI nodes in the communication system, and the two AI nodes may be respectively responsible for different AI tasks.

It may be understood that the foregoing function division of the AI node #1 and the AI node #2 is described as an example, and the function division of the AI node #1 and the AI node #2 is not limited in this disclosure.

It may be further understood that the AI node #1 and the AI node #2 may be independent devices, or may be integrated into a same device to implement different functions, may be network elements in a hardware device, may be software functions running on dedicated hardware, or may be instantiated virtualization functions on a platform (for example, a cloud platform). Specific forms of the AI node #1 and the AI node #2 are not limited in this disclosure.

It may be further understood that, in actual communication, further division may be performed on the AI node, or more AI nodes may be included. For example, the communication system includes at least two AI nodes (for example, the AI node #1, the AI node #2, and the AI node #3), and the AI nodes are responsible for different functions. For example, each of the at least two AI nodes may set up an AI connection to the terminal device, or some of the at least two AI nodes may set up an AI connection to the terminal device.

It may be further understood that names of interfaces between the devices in FIG. 2 and FIG. 3 are merely examples. In specific implementation, the interfaces may have other names. This is not specifically limited in this disclosure.

It may be further understood that FIG. 2 and FIG. 3 are examples for description. For example, the communication systems shown in FIG. 2 and FIG. 3 may further include more devices, for example, more terminal devices, more AI nodes, or more network devices. For another example, AI tasks may be published between terminal devices. For example, AI tasks are directly published between terminal devices. For another example, a terminal device publishes an AI task to another terminal device via an AI node (for example, the AI node #1 or the AI node #2).

The communication system provided in embodiments of this disclosure is briefly described above with reference to FIG. 2 and FIG. 3. The following describes a communication method provided in embodiments of this disclosure. The method described below may be applied to the system shown in FIG. 2 or FIG. 3.

FIG. 4 is a schematic of a communication method 400 according to an embodiment of this disclosure. The method 400 may include the following steps.

410. A communication apparatus receives information about an AI connection.

In this disclosure, the communication apparatus may be a terminal device, or may be a chip, a chip system, or a circuit used in the terminal device. This is not limited.

The AI connection indicates a connection between the communication apparatus and an AI node. The communication apparatus and the AI node may transmit, through the AI connection, AI-related signaling and perform an AI-related operation.

For example, the AI connection between the communication apparatus and the AI node may be implemented by a connection between the communication apparatus and a network device and a connection between the network device and the AI node. In an embodiment, the AI connection between the communication apparatus and the AI node may be implemented by a radio bearer (RB) (or referred to as an air interface bearer or an air interface radio bearer) set up between the communication apparatus and the network device and the connection between the network device and the AI node.

For example, the communication apparatus sends a message to the AI node through the AI connection, which may include: The communication apparatus sends the message to the network device, and the network device forwards the message to the AI node. In other words, the network device may be similar to a relay device between the communication apparatus and the AI node. The communication apparatus may send the message to the network device based on the radio bearer set up between the communication apparatus and the network device. The network device may forward the message to the AI node based on the connection (for example, an AI-2 interface) between the network device and the AI node.

The information about the AI connection, or referred to as configuration information of the AI connection, indicates information related to the AI connection. The communication apparatus and/or the AI node may process an AI-related operation based on the information about the AI connection. For information about the AI connection, refer to the following detailed descriptions.

420. The communication apparatus sets up the AI connection to the AI node based on the information about the AI connection.

In other words, the communication apparatus and the AI node may set up the AI connection based on the information about the AI connection, to communicate with each other through the AI connection. For example, the communication apparatus may directly set up the AI connection to the AI node based on the information about the AI connection after receiving the information about the AI connection. Alternatively, the communication apparatus may set up the AI connection to the AI node based on the information about the AI connection after receiving/sending an indication or triggering or when a preset condition is met.

Optionally, the method 400 further includes step 430: The communication apparatus communicates with the AI node through the AI connection.

In this disclosure, the communication apparatus may receive the information about the AI connection, and set up the AI connection to the AI node based on the information about the AI connection. In this way, the AI node and the communication apparatus may communicate with each other through the AI connection, for example, send and/or receive an AI task, or send and/or receive a processing result of the AI task, to implement convergence of AI and a wireless network.

Optionally, before step 410, the method 400 further includes: The communication apparatus sends a request message, where the request message is for requesting to set up the AI connection between the communication apparatus and the AI node. Further, optionally, the communication apparatus receives a response message, where the response message includes the information about the AI connection. The request message may also be referred to as, for example, an AI connection setup request message. Optionally, the request message further includes indication information of a request type, and the request type may indicate a purpose of setting up the AI connection. For example, the request message directly carries the request type, and may directly indicate the request type. For another example, the request message carries indication information, and the indication information may indicate the request type.

In an example, the request type includes at least one of the following: model training, data collection, task publishing, and the like. For example, if the request type includes model training, it indicates that a UE requests to set up an AI connection to perform model training. For another example, if the request type includes task publishing, it indicates that a UE requests to set up an AI connection to publish an AI task through the AI connection.

In this way, before setting up the AI connection to the AI node, the communication apparatus may set up the AI connection to the AI node by initiating a request. Therefore, when the communication apparatus needs to perform a related operation through the AI connection, for example, publishing an AI task, the communication apparatus may actively initiate a request for setting up the AI connection, to avoid a resource waste caused by not using the AI connection after the AI connection is set up.

Optionally, at least before step 420, the method 400 further includes: The communication apparatus receives indication information from the AI node, where the indication information is for triggering the communication apparatus to set up the AI connection to the AI node. Further, optionally, after receiving the indication information, the communication apparatus may send the request message to the AI node, to request to set up the AI connection between the communication apparatus and the AI node.

In this way, before the AI connection is set up between the communication apparatus and the AI node, the AI node may set up the AI connection to the communication apparatus through triggering. Therefore, when the AI node needs to perform a related operation through the AI connection, for example, publishing an AI task, the AI node may actively trigger the communication apparatus to send an AI connection setup request, to avoid a resource waste caused by not using the AI connection after the AI connection is set up.

The following describes the information about the AI connection in detail.

Optionally, the information about the AI connection includes an identifier of the AI connection, resource information of the AI connection, or radio bearer information.

(1) The identifier (ID) of the AI connection may be provided by the AI node. The AI connection may be identified as the AI connection between the communication apparatus and the AI node based on the identifier of the AI connection. For example, after receiving the request message from the communication apparatus, the AI node learns that the communication apparatus requests to set up the AI connection. Therefore, the AI node allocates the identifier of the AI connection.

(2) The resource information of the AI connection may be provided by the AI node. For example, after receiving the request message from the communication apparatus, the AI node learns that the communication apparatus requests to set up the AI connection. Therefore, the AI node configures a resource for the AI connection.

In an example, the resource information of the AI connection includes at least one of the following configured for the AI connection: a model, a dataset, and a computing resource.

For example, the resource information of the AI connection includes a model. In other words, the AI node may configure a model for the AI connection, and the model may also be referred to as a preset model. For the AI node, in an example, the AI node may process, based on the model, data uploaded by the communication apparatus. For the communication apparatus, in an example, the communication apparatus may process the model. For example, the communication apparatus performs model training, model testing, model fusion, and the like based on the model.

For another example, the resource information of the AI connection includes a dataset. In other words, the AI node may configure a dataset for the AI connection, and the dataset may also be referred to as a preset dataset. For the AI node, in an example, the AI node may manage the dataset. For the communication apparatus, in an example, the communication apparatus may perform AI measurement based on the dataset.

In an embodiment, if the communication apparatus sends the request message, and the request message includes the request type, the AI node may allocate a dataset based on the request type, that is, the dataset may be a UE-specific dataset or a mission-specific dataset.

For another example, the resource information of the AI connection includes a computing resource. In other words, the AI node may configure a computing resource for the AI connection, and the computing resource may also be referred to as a preset computing resource. The computing resource may be used by the communication apparatus or the AI node to perform an AI-related operation. For example, the communication apparatus or the AI node uses the computing resource to process an AI task.

The foregoing separately describes the information. It may be understood that the foregoing information may also be used in combination.

Within a validity period of the AI connection, the AI node may dynamically maintain and update the resource information of the AI connection. For example, the AI node may update a resource of the AI connection. In addition, if the resource information of the AI connection is updated, the AI node may send updated resource information of the AI connection to the communication apparatus through the AI connection, or send the updated resource information of the AI connection to the communication apparatus as required. The AI node and the communication apparatus may set up an AI connection again based on the updated resource information of the AI connection.

It may be understood that, the foregoing mainly provides descriptions by using an example in which the AI node configures the identifier of the AI connection and the resource information of the AI connection for the AI connection. In an example, the identifier of the AI connection and the resource information of the AI connection may be configured by another apparatus. In this example, for example, the another apparatus sends the configured identifier of the AI connection and the configured resource information of the AI connection to the AI node, so that the AI node sends the configured identifier of the AI connection and the configured resource information of the AI connection to the communication apparatus. For another example, the another apparatus sends the configured identifier of the AI connection and the configured resource information of the AI connection to the AI node, and the another apparatus sends the configured identifier of the AI connection and the configured resource information of the AI connection to the communication apparatus.

For differentiation, the information about the AI connection (for example, the identifier of the AI connection and/or the resource information of the AI connection) provided by the AI node is referred to as first information of the AI connection.

(3) The information about the radio bearer may be provided by the network device. As described above, the AI connection between the communication apparatus and the AI node may be implemented by the radio bearer set up between the communication apparatus and the network device and the connection between the network device and the AI node. Therefore, the network device may configure the information about the radio bearer, and associate the information about the radio bearer with the AI connection. In this way, the communication apparatus can communicate with the AI node through the AI connection.

For example, the communication apparatus sends the request message to the AI node via the network device, and the AI node sends the first information of the AI connection to the communication apparatus via the network device. After receiving the first information of the AI connection, the network device learns that the AI node accepts (or agrees to) the request of the communication apparatus. Therefore, the network device configures the information about the radio bearer, and associates the information about the radio bearer with the identifier of the AI connection in the first information of the AI connection (if the first information does not include the identifier of the AI connection, the AI connection is learned in another manner).

In an embodiment, the network device determines the information about the radio bearer based on the resource information of the AI connection. For example, the resource information of the AI connection includes a model configured for the AI connection, and the network device configures the radio bearer based on the model, for example, configures a protocol layer included in a protocol stack, and/or configures a parameter of each protocol layer. For example, environment parameters, such as residual computing powers of a transmitter and a receiver or a channel parameter between the transmitter and the receiver, are input to the model configured for the AI connection, and configuration parameters of the protocol layers, such as a frame structure of a physical layer, a segmentation condition of a medium access control (MAC) layer, a parameter related to a scheduling algorithm, a retransmission condition of a radio link control (RLC) layer, and a parameter related to a header compression algorithm of a packet data convergence protocol (PDCP) layer, are output by the model. The foregoing is an example for description.

A manner in which the network device configures the information about the radio bearer is described in detail below with reference to a method 800.

The architecture shown in FIG. 2 or FIG. 3 is used as an example. The AI node in this embodiment of this disclosure may be an AI node #1, or may be an AI node #2. This is not limited. The following describes two possible cases with reference to the AI node.

In a first possible case, the AI node is the AI node #1.

In this case, the AI connection represents a connection between the communication apparatus and the AI node #1. The system shown in FIG. 2 or FIG. 3 is used as an example. An interface between the communication apparatus and the AI node #1 is referred to as an AI-1 interface. That the communication apparatus communicates with the AI node #1 through the AI connection in step 430 may alternatively be that the communication apparatus communicates with the AI node #1 through the AI-1 interface.

In this case, the AI node that configures the first information of the AI connection for the AI connection may be the AI node #1. Alternatively, an apparatus that configures the first information of the AI connection for the AI connection may be another apparatus. The another apparatus sends the first information of the AI connection configured for the AI connection to the AI node #1, and then the AI node #1 sends the first information of the AI connection to the communication apparatus. Alternatively, the another apparatus sends the first information of the AI connection to the AI node #1 and the communication apparatus. Alternatively, another apparatus may configure the resource information of the AI connection, the AI node #1 configures the identifier of the AI connection, the another apparatus sends the resource information of the AI connection configured for the AI connection to the AI node #1, and then the AI node #1 sends the resource information of the AI connection and the identifier that is of the AI connection and that is configured by the AI node #1 to the communication apparatus.

Optionally, that the communication apparatus communicates with the AI node #1 through the AI connection includes: The communication apparatus sends an AI message to the AI node #1 through the AI connection, and/or the AI node #1 sends an AI message to the communication apparatus through the AI connection.

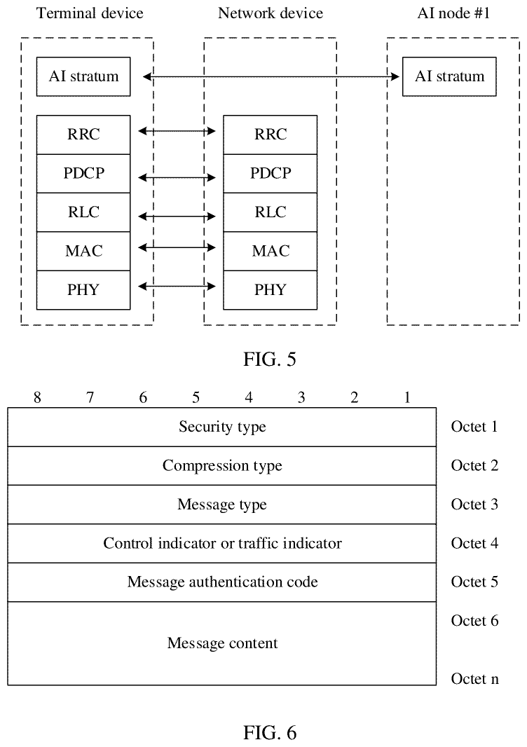

FIG. 5 is a schematic of a protocol stack for communication between the communication apparatus and the AI node #1.

As shown in FIG. 5, the communication apparatus may communicate with the AI node #1 through an AI stratum. For the communication apparatus, a message may be transferred between the AI stratum and an RRC layer. For example, the AI stratum transfers, to the RRC layer, a message sent by the communication apparatus to the AI node, or the RRC layer transfers, to the AI stratum, a message sent by the AI node to the communication apparatus.

For example, the communication apparatus sends an RRC message to the network device, where the RRC message carries the AI message (or may be referred to as an AI stratum message); and the network device sends the AI message to the AI node. For another example, the AI node sends the AI message to the network device, and the network device sends an RRC message to the communication apparatus, where the RRC message carries the AI message. In other words, the network device may use the RRC message as a container to carry the AI message.

It may be understood that FIG. 5 is an example for description. The protocol stack for communication between the communication apparatus and the AI node #1 may be flexibly configured. This is not limited herein. In addition, FIG. 5 is mainly described by using an example in which the communication apparatus is a terminal device and transmission is performed between the terminal device and the AI node #1 via the network device.

Optionally, the AI message indicates at least one of the following information: a security type, a compression type, a message type, a control indicator or a traffic indicator, a message authentication code, and message content. In an example, the AI message may directly include at least one piece of the foregoing information, to directly indicate the at least one piece of the foregoing information; or the AI message may include corresponding indication information of the at least one piece of the foregoing information, to indirectly indicate the at least one piece of the foregoing information.

FIG. 6 is a schematic of an information element format of the AI message. The following describes the information.

(1) The security type indicates an encryption method used for the AI message. If the AI message includes the security type, the AI message may be decrypted based on the security type. If the AI message does not include the security type, in an embodiment, the AI message may be decrypted based on a default encryption method. In other words, in this case, the encryption method used for the AI message may be pre-agreed or predefined.

(2) The compression type indicates a compression method used for the compression type. If the AI message includes the compression type, the AI message may be decompressed based on the compression type. If the AI message does not include the compression type, in an embodiment, the AI message may be decompressed based on a default compression method. In other words, in this case, the compression method used for the AI message may be pre-agreed or predefined.

(3) The message type indicates a type of the AI message.

In an embodiment, the type of the AI message is distinguished by using different values of bits. For example, if the message type is 0000, it indicates that the AI message is for describing a model parameter; if the message type is 0001, it indicates that the AI message is for updating a model; if the message type is 0010, it indicates that the AI message is for describing a dataset; if the message type is 0011, it indicates that the AI message is for updating a dataset; if the message type is 0100, it indicates that the AI message is for describing a task; or if the message type is 0101, it indicates that the AI message is used by the AI node to switch or reselect a parameter. It may be understood that the foregoing is an example for description.

If the AI message includes the message type, the type of the AI message may be determined based on the message type. If the AI message does not include the message type, in an embodiment, the type of the AI message may be learned by parsing the AI message. Alternatively, in another embodiment, different formats of the AI message may correspond to different types of the AI message. In other words, the type of the AI message may be determined based on a format of the AI message. For example, the AI message has a plurality of formats. If the format of the AI message is a first format, it indicates that the AI message is for describing a model parameter; if the format of the AI message is a second format, it indicates that the AI message is for updating a model; if the format of the AI message is a third format, it indicates that the AI message is for describing a dataset; if the format of the AI message is a fourth format, it indicates that the AI message is for updating a dataset; if the format of the AI message is a fifth format, it indicates that the AI message is for describing a task; or if the format of the AI message is a sixth format, it indicates that the AI message is used by the AI node to switch or reselect a parameter. It may be understood that the foregoing is an example for description.

(4) The control indicator or the traffic indicator indicates whether control signaling or AI-related data is transmitted in the AI message. For example, if the AI message includes the control indicator, it indicates that the control signaling is transmitted in the AI message. For another example, if the AI message includes the traffic indicator, it indicates that the AI-related data is transmitted in the AI message.

(5) The message authentication code indicates a verification code for integrity verification. If the AI message includes the message authentication code, integrity verification may be performed based on the message authentication code. If the AI message does not include the message authentication code, in some embodiments, integrity verification may be performed based on a default verification code. In other words, in this case, the verification code for performing integrity verification on the AI message may be pre-agreed or predefined.

It may be understood that the information included in the AI message is merely an example for description.

That the communication apparatus communicates with the AI node #1 through the AI connection, or the communication apparatus and the AI node #1 transmit the AI message through the AI connection may include the following examples.

Example 1: The communication apparatus publishes a first AI task to the AI node #1 through the AI connection. Correspondingly, the AI node #1 receives the first AI task. In this disclosure, for differentiation, a task published by the communication apparatus is referred to as the first AI task.

In a first possible implementation, after receiving the first AI task, the AI node #1 processes the first AI task.

In this manner, after completing the first AI task, the AI node #1 may send a processing result of the first AI task to the communication apparatus.

In a second possible implementation, after receiving the first AI task, the AI node #1 publishes the first AI task to another communication apparatus (for example, another terminal device or another AI node), and the another communication apparatus processes the first AI task. In other words, the communication apparatus may publish the first AI task to the another communication apparatus via the AI node #1. The another communication apparatus may be referred to as a communication apparatus for coordinately completing an AI task. For differentiation, the another communication apparatus is referred to as a coordinating communication apparatus. There is at least one coordinating communication apparatus.

For example, after the AI node #1 receives the first AI task, the AI node #1 determines a coordinating communication apparatus, and publishes the first AI task to the coordinating communication apparatus through an AI connection between the AI node #1 and the coordinating communication apparatus. It may be understood that publishing of the first AI task by the AI node #1 to the coordinating communication apparatus includes complete task publishing of the first AI task and/or partial task publishing of the first AI task. For another example, the communication apparatus determines a coordinating communication apparatus, and the communication apparatus publishes the first AI task to the coordinating communication apparatus via the AI node #1. After receiving the first AI task, the AI node #1 may publish the first AI task to the coordinating communication apparatus through an AI connection between the AI node #1 and the coordinating communication apparatus. For another example, the communication apparatus determines a coordinating communication apparatus, and the communication apparatus publishes a first subtask of the first AI task to the AI node #1, and publishes a second subtask of the first AI task to the coordinating communication apparatus via the AI node #1. After receiving the first AI task, the AI node #1 may publish the second subtask of the first AI task to the coordinating communication apparatus through an AI connection between the AI node #1 and the coordinating communication apparatus.

In this manner, after completing the first AI task, the coordinating communication apparatus may send a processing result of the first AI task to the AI node #1, and then the AI node #1 sends the processing result of the first AI task to the communication apparatus. Alternatively, after completing the first AI task, the coordinating communication apparatus may directly send a processing result of the first AI task to the communication apparatus.

It should be noted that, based on a task publishing status, that the coordinating communication apparatus or the AI node #1 completes the first AI task includes: completing the entire first AI task, or completing a subtask (or referred to as a partial/decomposed task) of the first AI task.

In a third possible implementation, after receiving the first AI task, the AI node #1 sends an indication to an AI node #2, and the AI node #2 processes the first AI task. In other words, the communication apparatus may publish the first AI task to the AI node #2 via the AI node #1. In this implementation, the AI node #2 may be considered as a coordinating communication apparatus. It may be understood that the first AI task published by the AI node #1 to the AI node #2 includes a complete task of the first AI task and/or a partial task of the first AI task.

FIG. 3 is used as an example. The AI node #1 may send the indication to the AI node #2 through an AI-4 interface. In this manner, after completing the first AI task, the AI node #2 may send a processing result of the first AI task to the AI node #1, and then the AI node #1 sends the processing result of the first AI task to the communication apparatus. Alternatively, after completing the first AI task, the AI node #2 may directly send a processing result of the first AI task to the communication apparatus. FIG. 3 is used as an example. The AI node #2 may send the processing result of the first AI task to the communication apparatus through an AI-6 interface.

It should be noted that, based on a task publishing status, that the AI node #1 or the AI node #2 completes the first AI task includes: completing the entire first AI task, or completing a subtask (or referred to as a partial/decomposed task) of the first AI task.

It may be understood that, in the second possible implementation or the third possible implementation, if the AI node #1 publishes the first AI task to the coordinating communication apparatus or the AI node #2, the coordinating communication apparatus or the AI node #2 may process the first AI task, the coordinating communication apparatus and the AI node #1 may jointly process the first AI task, or the AI node #2 and the AI node #1 jointly process the first AI task. That the coordinating communication apparatus and the AI node #1 jointly process the first AI task is used as an example. For example, the coordinating communication apparatus and the AI node #1 may be separately responsible for a partial task of the first AI task.

Example 2: The AI node #1 publishes a second AI task to the communication apparatus through the AI connection. Correspondingly, the communication apparatus receives the second AI task. In this disclosure, for differentiation, a task published by the AI node (for example, the AI node #1 or the AI node #2) is referred to as the second AI task.

In a possible implementation, after receiving the second AI task, the communication apparatus processes the second AI task. In this manner, after completing the second AI task, the communication apparatus may send a processing result of the second AI task to the AI node #1.

In another possible implementation, after receiving the second AI task, the communication apparatus publishes the second AI task to a coordinating communication apparatus, and the coordinating communication apparatus processes the second AI task. In other words, the AI node #1 may publish the second AI task to the coordinating communication apparatus via the communication apparatus. It may be understood that the publishing of the second AI task by the communication apparatus to the coordinating communication apparatus includes: complete task publishing of the second AI task and/or partial task publishing of the second AI task.

For example, after the communication apparatus receives the second AI task, the communication apparatus determines a coordinating communication apparatus, and publishes the second AI task to the coordinating communication apparatus. For another example, the AI node #1 determines a coordinating communication apparatus, and the AI node #1 publishes the second AI task to the communication apparatus through an AI connection between the AI node #1 and the communication apparatus. After receiving the second AI task, the communication apparatus may publish the second AI task to the coordinating communication apparatus.

In this manner, after completing the second AI task, the coordinating communication apparatus may send a processing result of the second AI task to the AI node #1 through an AI connection between the coordinating communication apparatus and the AI node #1. Alternatively, after completing the second AI task, the coordinating communication apparatus may send a processing result of the second AI task to the communication apparatus, and the communication apparatus sends the processing result of the second AI task to the AI node #1 through the AI connection between the communication apparatus and the AI node #1. It should be noted that, based on a task publishing status, that the communication apparatus or the coordinating communication apparatus completes the second AI task includes: completing the entire second AI task, or completing a subtask (or referred to as a partial/decomposed task) of the second AI task.

It should be noted that, based on the task publishing status, that the coordinating communication apparatus completes the second AI task includes: completing the entire second AI task, or completing a subtask (or referred to as a partial/decomposed task) of the second AI task.

It may be understood that the AI node #1 may publish an AI task to at least one communication apparatus. For example, the AI node #1 may publish an AI task to each communication apparatus through an AI connection to each communication apparatus.

It can be learned from the foregoing Example 1 and Example 2 that both the communication apparatus and the AI node #1 may actively publish an AI task.

When a processing result of the AI task is fed back, the processing result of the AI task may be directly fed back after the AI task is processed. Alternatively, optionally, the processing result of the AI task is fed back when a preset condition is met. Example 1 is used as an example. For example, when a preset condition is met, the AI node #1 sends the processing result of the first AI task to the communication apparatus. Example 2 is used as an example. For example, when a preset condition is met, the communication apparatus sends the processing result of the second AI task to the AI node #1. The preset condition may also be referred to as a trigger condition or a feedback condition. This is not limited.

In a first possible implementation, the preset condition is predefined. For example, the preset condition is predefined in a standard. For example, there is a correspondence between an AI task and a preset condition. After an AI task is determined, a preset condition corresponding to the AI task is also determined. In other words, a processing result of the AI task may be reported based on the preset condition corresponding to the AI task.

In an example, the correspondence between an AI task and a preset condition may exist in a form similar to Table 1.

TABLE 1

| AI task | Description | Preset condition |
|---|---|---|
| AI-M1 | Model failure test | Event: Performance degrades |
| | | to a threshold. |
| AI-M2 | Model performance | Periodic |
| | test | |
| AI-M3 | Model training test | Periodic |
| AI-M4 | Data collection | Event: (1) Move to a specific area. |
| | | (2) Model performance degrades. |
| . . . | | |

Table 1 is used as an example. The preset condition may be, for example, periodic reporting, location-triggered reporting, or model performance-triggered reporting. This is not limited. For example, if the AI task is an AI-M1 task, namely, a model failure test, a processing result of the AI-M1 task may be reported when model performance degrades to a threshold. For another example, if the AI task is an AI-M2 task, namely, a model performance test, a processing result of the AI-M2 task may be periodically reported, and a period (that is, a reporting time interval) may be further predefined. For another example, if the AI task is an AI-M4 task, namely, data collection, a processing result of the AI-M4 task may be reported when model performance degrades (for example, when the model performance degrades to a threshold, or degradation occurs) or when a specific area is moved to (for example, a location change exceeds a threshold). The threshold in Table 1 may be predefined, for example, predefined in a standard.

It may be understood that Table 1 is an example for description, and all variations belonging to Table 1 are applicable to this disclosure. For example, Table 1 may further include more AI tasks. For another example, “performance degrades to a threshold” in Table 1 may alternatively be “performance reaches a preset condition”.

In a second possible implementation, when an AI task is published, indication information of a preset condition corresponding to the AI task is carried. For example, when an AI task is published, a preset condition corresponding to the AI task is directly carried. For another example, when an AI task is published, indication information is carried, and the indication information may indicate a preset condition corresponding to the AI task.

Example 1 is used as an example. The first AI task includes a preset condition corresponding to the first AI task. For example, the communication apparatus sends a first AI message to the AI node #1 through the AI connection, where the first AI message is for publishing the first AI task, and the first AI message includes the preset condition corresponding to the first AI task. Assuming that the AI node #1 sends the processing result of the first AI task to the communication apparatus, the AI node #1 sends the processing result of the first AI task to the communication apparatus when the preset condition corresponding to the first AI task is met.

Example 2 is used as an example. The second AI task includes a preset condition corresponding to the second AI task. For example, the AI node #1 sends a second AI message to the communication apparatus through the AI connection, where the second AI message is for publishing the second AI task, and the second AI message includes the preset condition corresponding to the second AI task. Assuming that the communication apparatus sends the processing result of the second AI task to the AI node #1, the communication apparatus sends the processing result of the second AI task to the AI node #1 when the preset condition corresponding to the second AI task is met.

For example, for the preset condition corresponding to the AI task, refer to the descriptions in Table 1. If the AI task is a model performance test task or a model training test task, a processing result of the AI task can be periodically reported. For another example, if the AI task is a model failure test, a processing result of the AI task may be reported when performance degrades to a threshold. For another example, if the AI task is data collection, a processing result of the AI task may be reported when model performance degrades (for example, when the model performance degrades to a threshold, or degradation occurs) or when a specific area is moved to (for example, a location change exceeds a threshold).

When a processing result of an AI task is fed back, information fed back for different AI tasks may be different. In an example, Table 2 shows a correspondence between an AI task and feedback information.

TABLE 2

| AI | | Feedback information (or referred |
|---|---|---|
| task | Description | to as a reporting parameter) |
| AI-M1 | Model failure test | Location, timestamp, and error amount |
| AI-M2 | Model performance | Location, timestamp, and error amount |
| | test | |
| AI-M3 | Model training test | Location, timestamp, and convergence |
| | | time |
| AI-M4 | Data collection | Location, timestamp, and data sample |
| . . . | | |

Table 2 is used as an example. For example, if the AI task is an AI-M1 task, namely, a model failure test, a sent processing result of the AI-M1 task may include a location of a model failure, a model error amount, and a model timestamp. The model timestamp may be, for example, model failure time.

For another example, if the AI task is an AI-M3 task, namely, a model training test, a sent processing result of the AI-M3 task may include a location of the model training test, model training convergence time, and a model timestamp. The model timestamp may be, for example, model generation time.

It may be understood that Table 2 is an example for description, and all variations belonging to Table 2 are applicable to this disclosure. For example, Table 2 may further include more AI tasks. For another example, Table 2 may further include more pieces of feedback information. For example, the feedback information may further include an identifier of a model, inference performance of the model, and an identifier of the AI node (for example, an identifier of an AI node that processes an AI task).

In a second possible case, the AI node is the AI node #2.

In this case, the AI connection represents a connection between the communication apparatus and the AI node #2. The system shown in FIG. 3 is used as an example. An interface between the communication apparatus and the AI node #2 is referred to as an AI-6 interface. That the communication apparatus communicates with the AI node #2 through the AI connection in step 430 may alternatively be that the communication apparatus communicates with the AI node #2 through the AI-6 interface.

In this case, the AI node that configures the first information of the AI connection for the AI connection may be an AI node #1, and the AI node #1 sends the first information of the AI connection configured for the AI connection to the AI node #2. Alternatively, an apparatus that configures the first information of the AI connection for the AI connection may be another apparatus, and the another apparatus sends the first information of the AI connection configured for the AI connection to the AI node #2. Alternatively, another apparatus may configure the resource information of the AI connection, the AI node #1 configures the identifier of the AI connection, the AI node #1 sends the identifier of the AI connection configured for the AI connection to the AI node #2, and the another apparatus sends the resource information of the AI connection configured for the AI connection to the AI node #2. Alternatively, another apparatus may configure the resource information of the AI connection, the AI node #2 configures the identifier of the AI connection, and the another apparatus sends the resource information of the AI connection configured for the AI connection to the AI node #2. Alternatively, the AI node #2 may configure the first information of the AI connection by itself.

Optionally, that the communication apparatus communicates with the AI node #2 through the AI connection includes: The communication apparatus sends an AI message to the AI node #2 through the AI connection, and/or the AI node #2 sends an AI message to the communication apparatus through the AI connection. For the AI message, refer to the descriptions in the first possible case. Details are not described herein again.

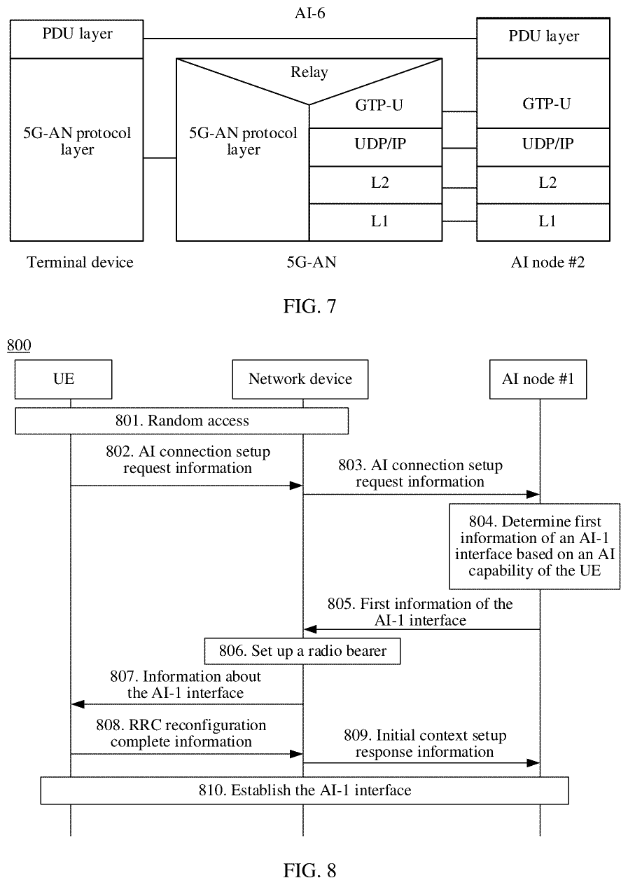

FIG. 7 is a schematic of a protocol stack for communication between the communication apparatus and the AI node #2.

The communication apparatus may communicate with the AI node #2 by using a protocol stack shown in FIG. 7. As shown in FIG. 7, for example, the communication apparatus is a UE, and the network device is a 5G access network (AN). There is a corresponding protocol data unit (PDU) layer between the UE and the AI node #2. The UE and the AI node #2 may communicate with each other via the 5G AN. The 5G AN may, for example, serve as a relay device to forward information sent by the UE to the AI node #2, and/or forward information sent by the AI node #2 to the UE.

It may be understood that FIG. 7 is an example for description. The protocol stack for communication between the communication apparatus and the AI node #2 may be flexibly configured. This is not limited herein. In addition, FIG. 7 is mainly described by using an example in which transmission is performed between the communication apparatus and the AI node #2 via the network device.

That the communication apparatus communicates with the AI node #2 through the AI connection, or the communication apparatus and the AI node #2 transmit the AI message through the AI connection may include the following examples.

Example 1: The communication apparatus publishes a first AI task to the AI node #2 through the AI connection. Correspondingly, the AI node #2 receives the first AI task.

As described above, the AI node #1 is responsible for processing an AI task with lower overheads, and the AI node #2 is responsible for processing an AI task with higher overheads. Therefore, the communication apparatus may publish different AI tasks to different AI nodes. For example, the communication apparatus publishes an AI task with lower processing overheads to the AI node #1, and the communication apparatus publishes an AI task with higher processing overheads to the AI node #2.

In a first possible implementation, after receiving the first AI task, the AI node #2 processes the first AI task.

In this manner, after completing the first AI task, the AI node #2 may send a processing result of the first AI task to the communication apparatus.

In a second possible implementation, after receiving the first AI task, the AI node #2 publishes the first AI task to a coordinating communication apparatus (including publishing all and/or a partial task of the first AI task), and the coordinating communication apparatus processes the first AI task. In other words, the communication apparatus may publish the first AI task to the another communication apparatus via the AI node #2. For details, refer to the related descriptions in the first possible case. Details are not described herein again.

Example 2: The AI node #2 publishes a second AI task to the communication apparatus through the AI connection. Correspondingly, the communication apparatus receives the second AI task.

In a possible implementation, after receiving the second AI task, the communication apparatus processes the second AI task. In this manner, after completing the second AI task, the communication apparatus may send a processing result of the second AI task to the AI node #2.

In another possible implementation, after receiving the second AI task, the communication apparatus publishes the second AI task to a coordinating communication apparatus (including publishing all and/or a partial task of the second AI task), and the coordinating communication apparatus processes the second AI task. In other words, the AI node #2 may publish the second AI task to the coordinating communication apparatus via the communication apparatus. For details, refer to the related descriptions in the first possible case. Details are not described herein again.

It may be understood that the AI node #2 may publish an AI task to at least one communication apparatus. For example, the AI node #2 may publish an AI task to each communication apparatus through an AI connection to each communication apparatus.

It can be learned from the foregoing Example 1 and Example 2 that both the communication apparatus and the AI node #2 may actively publish an AI task.

When a processing result of the AI task is fed back, the processing result of the AI task may be directly fed back after the AI task is processed. Alternatively, optionally, the processing result of the AI task is fed back when a preset condition is met. Example 1 is used as an example. For example, when a preset condition is met, the AI node #2 sends the processing result of the first AI task to the communication apparatus. For details, refer to the descriptions in the first possible case. Details are not described herein again.

When a processing result of an AI task is fed back, information fed back for different AI tasks may be different. For details, refer to the descriptions in the first possible case. Details are not described herein again.

For ease of understanding, the following uses a UE to represent the communication apparatus, and describes embodiments of this disclosure by using examples with reference to FIG. 8 to FIG. 12. For details about related steps or terms, refer to the foregoing descriptions. In the following embodiments, to distinguish an AI connection between the UE and the AI node #1 and an AI connection between the UE and the AI node #2, the AI-1 interface and the AI-6 interface are used for description.

FIG. 8 is a schematic flowchart of a communication method 800 according to an embodiment of this disclosure. The method 800 may be for implementing a solution such as the method 400. For example, the method 800 may be applied to a scenario in which the UE establishes the AI-1 interface with the AI node #1. In an example, the method 800 may include the following steps.

801. A UE initiates random access (RA) to a network device.

If the UE does not set up a communication connection to the network device, the UE may first access the network device, to communicate with the network device. In an example, the UE may access the network device by initiating random access.

802. The UE sends AI connection setup request information to the network device.

In a possible implementation, in a process in which the UE sets up a radio resource control (RRC) connection to the network device, the UE sends the AI connection setup request information to the network device. In an example, the AI connection setup request information is carried in an RRC connection setup complete message.

The AI connection setup request information is for requesting to establish an AI-1 interface between the UE and an AI node #1. In other words, the AI connection setup request information is for requesting to set up an AI connection between the UE and the AI node #1. Optionally, the AI connection setup request information includes a request type, and the request type may indicate a purpose of establishing the AI-1 interface. For the request type, refer to the related descriptions in the method 400. Details are not described herein again.

803. The network device sends the AI connection setup request information to the AI node #1.

After receiving the AI connection setup request information sent by the UE, the network device forwards the AI connection setup request information to the AI node #1. That is, the AI connection setup request information may be transparently transmitted to the AI node #1 via the network device.

In a possible implementation, the network device sends an initial UE message to the AI node #1, where the initial UE message carries the AI connection setup request information.

804. The AI node #1 determines first information of the AI-1 interface based on an AI capability of the UE.

After receiving the AI connection setup request information, the AI node #1 learns that the UE requests to establish the AI-1 interface. The AI node #1 may first determine the AI capability of the UE, and then determine the first information of the AI-1 interface based on the AI capability of the UE. The AI capability of the UE may include, for example, at least one of the following: a priority of the UE, a maximum computing power supported by the UE, an AI task type supported by the UE, a hardware capability of the UE, and a security requirement of the UE.

In a possible implementation, a core network stores subscription information of the UE, the AI node #1 queries the subscription information of the UE from the core network, and the AI node #1 may learn of the AI capability of the UE based on the subscription information of the UE. The subscription information of the UE includes the AI capability of the UE. The architecture shown in FIG. 2 or FIG. 3 is used as an example. The AI node #1 may query the subscription information of the UE from the core network through an AI-3 interface.

The first information of the AI-1 interface includes resource information of the AI-1 interface (that is, resource information of the AI connection between the UE and the AI node #1). Optionally, an identifier of the AI-1 interface (that is, an identifier of the AI connection between the UE and the AI node #1) may be further included. For the first information of the AI-1 interface, refer to the related descriptions of the first information of the AI connection in the method 400.

Details are not described herein again.

The AI node #1 may determine the first information of the AI-1 interface based on the AI capability of the UE.

For example, if the priority of the UE is high, the AI node #1 may allocate more computing resources to the UE, or the AI node #1 preferentially allocates resource information of an AI-1 interface to the UE.

For another example, the AI node #1 may allocate, based on the AI task type supported by the UE, a model corresponding to the AI task.

For another example, if the maximum computing power supported by the UE is greater than or equal to a preset value, the AI node #1 may allocate a larger quantity of datasets to the UE.

805. The AI node #1 sends the first information of the AI-1 interface to the network device.

For example, the AI node #1 sends AI connection setup response information or AI connection setup accept information to the network device, where the AI connection setup response information or the AI connection setup accept information includes the first information of the AI-1 interface. If the AI node #1 sends the AI connection setup response information to the network device, the AI connection setup response information is for notifying that an AI connection setup request is accepted.

For another example, the AI node #1 sends initial context setup request (information to the network device, where the initial context setup request information includes the first information of the AI-1 interface. The initial context setup request information includes the first information of the AI-1 interface, where the first information may indicate that the AI node #1 accepts an AI connection setup request. Alternatively, the initial context setup request information includes the first information of the AI-1 interface and AI connection setup accept information. 806. The network device sets up a radio bearer.

The AI-1 interface may be implemented by a radio bearer set up between the UE and the network device and a connection between the network device and the AI node #1. Therefore, if the network device learns that the AI node #1 accepts establishment of the AI-1 interface for the UE, the network device may set up the radio bearer, and associate the radio bearer with the AI-1 interface (for example, associate the radio bearer with the identifier of the AI connection).

The radio bearer may identify a set of configuration parameters of an air interface protocol stack.

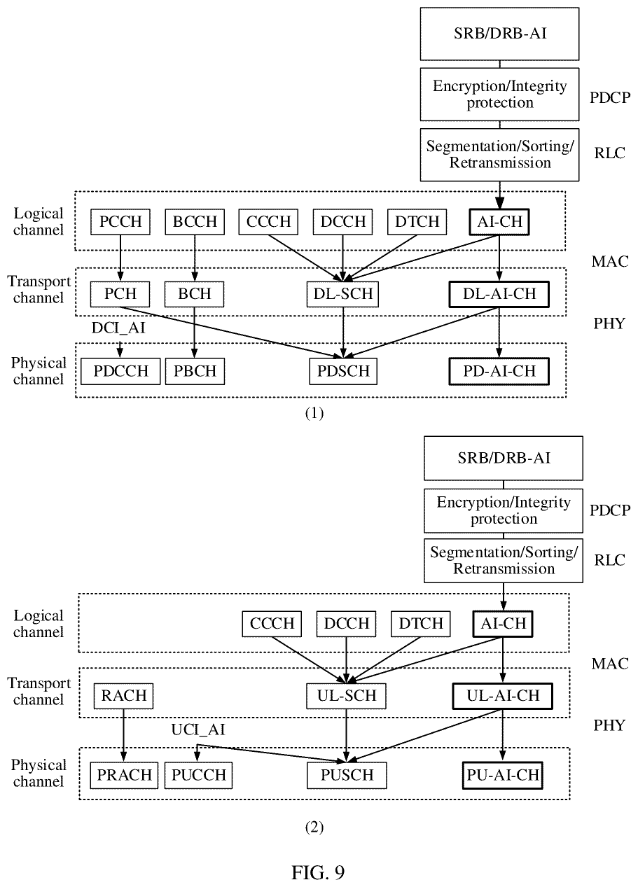

FIG. 9 is a schematic of the radio bearer. (1) in FIG. 9 shows a situation of downlink channel mapping, and (2) in FIG. 9 shows a situation of uplink channel mapping. The following uses the downlink channel mapping as an example for description with reference to several examples.

Example 1: The network device configures a logical channel AI-CH for the AI connection between the UE and the AI node #1. In other words, the radio bearer configured by the network device is transmitted on the logical channel AI-CH. In this disclosure, for differentiation, a logical channel corresponding to the AI connection between the UE and the AI node #1 is referred to as the AI-CH.

In this example, information about the logical channel may be mapped to a downlink shared channel (DL-SCH), and a transport channel may be mapped to a physical downlink shared channel (PDSCH). In other words, transmission is performed on the PDSCH.

Example 2: The network device configures a logical channel AI-CH and a transport channel DL-AI-CH for the AI connection between the UE and the AI node #1. In other words, the radio bearer configured by the network device is transmitted on the logical channel AI-CH and the transport channel DL-AI-CH. In this disclosure, for differentiation, a downlink transport channel corresponding to the AI connection between the UE and the AI node #1 is referred to as the DL-AI-CH.

In this example, information about the logical channel may be mapped to the transport channel DL-AI-CH, and the transport channel DL-AI-CH may be mapped to a PDSCH. In other words, transmission is performed on the PDSCH.

In a possible implementation, the network device indicates a transmission resource location by using a physical downlink control channel (PDCCH). Because both the transport channel DL-AI-CH and the DL-SCH are mapped to the PDSCH, whether the transmission resource location indicated by the PDCCH is a resource location of the DL-AI-CH or a resource location of the DL-SCH may be distinguished by using a radio network temporary identifier (RNTI) for scrambling the PDCCH.

In an example, if the PDCCH is scrambled by using an X-RNTI, the transmission resource location indicated by the PDCCH is the resource location of the DL-AI-CH; or if the PDCCH is scrambled by using another RNTI (different from the X-RNTI), the transmission resource location indicated by the PDCCH is the resource location of the DL-SCH.

Example 3: The network device configures a logical channel AI-CH, a transport channel DL-AI-CH, and a physical channel PD-AI-CH for the AI connection between the UE and the AI node #1. In other words, the radio bearer configured by the network device is transmitted by on the logical channel AI-CH, the transport channel DL-AI-CH, and the physical channel PD-AI-CH. In this disclosure, for differentiation, a downlink physical channel corresponding to the AI connection between the UE and the AI node #1 is referred to as the PD-AI-CH.

In this example, information about the logical channel may be mapped to the transport channel DL-AI-CH, and the transport channel DL-AI-CH may be mapped to the physical channel PD-AI-CH. In other words, transmission is performed on the PD-AI-CH.

In a possible implementation, the network device indicates a resource location of the PD-AI-CH by using a system message. If some physical channels PD-AI-CHs carry control information, the network device may further indicate, by using the system message, PD-AI-CHs on which control information exists. The control information indicates locations of different DL-AI-CH messages carried on the PD-AI-CHs.

Optionally, the network device indicates a resource occupation status of the PD-AI-CH by using downlink control information (DCI) (for example, referred to as DCI_AI). In an example, the DCI may be scrambled by using an RNTI (for differentiation, referred to as, for example, a Z-RNTI).

The foregoing mainly uses the downlink channel mapping as an example for description. An uplink channel is similar. For brevity, details are not described herein again.

807. The network device sends information about the AI-1 interface to the UE.

The information about the AI-1 interface includes the first information of the AI-1 interface. Optionally, the information about the AI-1 interface further includes information about the radio bearer. It may be understood that the information about the radio bearer may also be separately sent (for example, carried in different pieces of signaling) independent of the first information of the AI-1 interface, or may be sent together with the first information of the AI-1 interface (for example, carried in same piece of signaling). This is not limited.

For example, the network device sends AI connection setup response information or AI connection setup accept information to the UE, where the AI connection setup response information or the AI connection setup accept information includes the information about the AI-1 interface. If the network device sends the AI connection setup response information to the UE, the AI connection setup response information is for notifying that an AI connection setup request is accepted.

For another example, the network device sends RRC reconfiguration information to the UE, where the RRC reconfiguration information includes the information about the AI-1 interface. The RRC reconfiguration information includes the information about the AI-1 interface, where the information may indicate that the AI node #1 accepts an AI connection setup request. Alternatively, the RRC reconfiguration information includes the information about the AI-1 interface and the AI connection setup accept information.

808. The UE sends RRC reconfiguration complete information to the network device.

If the network device sends the RRC reconfiguration information to the UE in step 807, the UE sends the RRC reconfiguration complete information to the network device in step 808.

809. The network device sends initial context setup response information to the AI node #1.

If the AI node #1 sends the initial context setup request information to the network device in step 805, the network device sends the initial context setup response information to the AI node #1 in step 809.

810. Establish the AI-1 interface.

In a possible case, the UE sends the RRC reconfiguration complete information to the network device, the network device sends the initial context setup response information to the AI node #1, and the AI node #1 enables the AI-1 interface by default after receiving the initial context setup response information, to complete establishment of the AI-1 interface between the UE and the AI node #1.

It may be understood that step 808 and/or step 809 are/is used as an example for description. In practice, step 808 and/or step 809 may not be performed. For example, step 808 and step 809 do not need to be performed. To be specific, the network device sends information about the AI-1 interface to the UE, and the UE enables the AI-1 interface by default after receiving the information about the AI-1 interface, to complete establishment of the AI-1 interface between the UE and the AI node #1. For another example, step 808 does not need to be performed. To be specific, after the network device sends the information about the AI-1 interface to the UE, the network device sends the initial context setup response information to the AI node #1, and the AI node #1 enables the AI-1 interface by default after receiving the initial context setup response information, to complete establishment of the AI-1 interface between the UE and the AI node #1. For another example, step 809 does not need to be performed. To be specific, after the network device sends the information about the AI-1 interface to the UE by using the RRC reconfiguration information, the UE sends the RRC reconfiguration complete information to the network device, and the network device enables the AI-1 interface by default after receiving the RRC reconfiguration information, to complete establishment of the AI-1 interface between the UE and the AI node #1.

After the foregoing steps, the UE establishes the AI-1 interface with the AI node #1, that is, the AI-1 interface between the UE and the AI node #1 is enabled. Therefore, the UE may communicate with the AI node #1 through the AI-1 interface. For example, the UE sends an AI message to the AI node #1 through the AI-1 interface. For another example, the AI node #1 sends an AI message to the UE through the AI-1 interface. For related content of communication between the UE and the AI node #1 through the AI-1 interface, refer to the related descriptions in the method 400. Details are not described herein again.

With reference to FIG. 8, the foregoing describes an example of a scenario in which the UE establishes the AI-1 interface with the AI node #1. The method 800 may be implemented based on the architecture shown in FIG. 2. Based on the foregoing embodiment, the UE establishes the AI-1 interface with the AI node #1, so that an AI message can be transmitted through the established AI-1 interface, for example, publishing an AI task or receiving an AI task, thereby implementing convergence of a wireless network and AI.

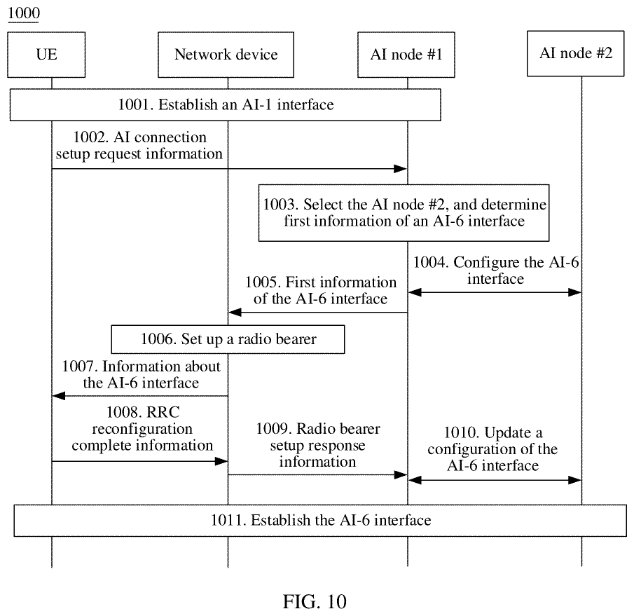

FIG. 10 is a schematic flowchart of a communication method 1000 according to another embodiment of this disclosure. The method 1000 may be for implementing a solution such as the method 400. For example, the method 1000 may be applied to a scenario in which the UE establishes the AI-6 interface with the AI node #2. In an example, the method 1000 may include the following steps.

1001. A UE establishes an AI-1 interface with an AI node #1.

For a method for establishing the AI-1 interface between the UE and the AI node #1, refer to the method 800. Details are not described herein again.

1002. The UE sends AI connection setup request information to the AI node #1.

The AI connection setup request information is for requesting to establish an AI-6 interface between the UE and an AI node #2. In other words, the AI connection setup request information is for requesting to set up an AI connection between the UE and the AI node #2. Optionally, the AI connection setup request information includes a request type, and the request type may indicate a purpose of establishing the AI-6 interface. For the request type, refer to the related descriptions in the method 400. Details are not described herein again.

1003. The AI node #1 selects the AI node #2, and determines first information of the AI-6 interface.

The first information of the AI-6 interface includes resource information of the AI-6 interface (that is, resource information of the AI connection between the UE and the AI node #2), and optionally, may further include an identifier of the AI-6 interface (that is, an identifier of the AI connection between the UE and the AI node #2). For the first information of the AI-6 interface, refer to the related descriptions of the first information of the AI connection in the method 400. Details are not described herein again.

After receiving the AI connection setup request information, the AI node #1 may first determine the AI capability of the UE, and then determine the first information of the AI-6 interface based on the AI capability of the UE. For the AI capability of the UE, a manner in which the AI node #1 learns of the AI capability of the UE, and a manner in which the AI node #1 determines the first information of the AI-6 interface based on the AI capability of the UE, refer to the descriptions in step 804. Details are not described herein again.

The AI node #1 may select the AI node #2 in any one of the following manners.

In a possible implementation, the AI node #1 may determine the AI node #2 based on the AI connection setup request information of the UE. For example, the AI node #1 may learn of, based on the request type in the AI connection setup request information of the UE, a purpose of establishing the AI-6 interface by the UE, and the AI node #1 selects an appropriate AI node #2 based on the purpose.

In another possible implementation, the AI node #1 determines the AI node #2 based on the AI capability of the UE. For example, the AI node #1 may learn of, based on the AI capability of the UE, an AI task supported by the UE. In this case, the AI node #1 may select an AI node #2 that can support the AI task. For another example, the AI node #1 may learn of, based on the AI capability of the UE, that a priority of the UE is high. In this case, the AI node #1 may select an AI node #2 with high computing power, for example, an AI node #2 whose computing power exceeds a threshold, to meet the UE as much as possible.

The foregoing two implementations are examples for description. For example, the AI node #1 may select the AI node #2 based on the request type and the AI capability of the UE.

1004. The AI node #1 and the AI node #2 configure the AI-6 interface.

After selecting the AI node #2, the AI node #1 may complete configuration of the AI-6 interface on a side of the AI node #2. For example, the AI node #1 sends the first information of the AI-6 interface to the AI node #2. In a possible implementation, the AI node #1 sends an AI connection configuration to the AI node #2, where the AI connection configuration includes the first information of the AI-6 interface.

1005. The AI node #1 sends the first information of the AI-6 interface to a network device.

For example, the AI node #1 sends AI connection setup response information or AI connection setup accept information to the network device, where the AI connection setup response information or the AI connection setup accept information includes the first information of the AI-6 interface. If the AI node #1 sends the AI connection setup response information to the network device, the AI connection setup response information is for notifying that an AI connection setup request is accepted.

For another example, the AI node #1 sends radio bearer setup request information to the network device, where the radio bearer setup request information includes the first information of the AI-6 interface. The radio bearer setup request information includes the first information of the AI-6 interface, where the first information indicates that the AI node #1 accepts an AI connection setup request. Alternatively, the radio bearer setup request information includes the first information of the AI-6 interface and AI connection setup accept information.

1006. The network device sets up a radio bearer.

The AI-6 interface may be implemented by a radio bearer set up between the UE and the network device and a connection between the network device and the AI node #2. Therefore, if the network device learns that the AI node #2 accepts establishment of the AI-6 interface for the UE, the network device may set up the radio bearer, and associate the radio bearer with the AI-6 interface (for example, associate the radio bearer with the identifier of the AI connection).

Step 1006 is similar to step 806. Details are not described herein again.

1007. The network device sends information about the AI-6 interface to the UE.

The information about the AI-6 interface includes the first information of the AI-6 interface. Optionally, the information about the AI-6 interface further includes information about the radio bearer. It may be understood that the information about the radio bearer may also be separately sent (for example, carried in different pieces of signaling) independent of the first information of the AI-6 interface, or may be sent together with the first information of the AI-6 interface (for example, carried in same piece of signaling). This is not limited.

For example, the network device sends AI connection setup response information or AI connection setup accept information to the UE, where the AI connection setup response information or the AI connection setup accept information includes the information about the AI-6 interface. If the network device sends the AI connection setup response information to the UE, the AI connection setup response information is for notifying that an AI connection setup request is accepted.

For another example, the network device sends RRC reconfiguration information to the UE, where the RRC reconfiguration information includes the information about the AI-6 interface. The RRC reconfiguration information includes the information about the AI-6 interface, where the information may indicate that the AI node #2 accepts an AI connection setup request. Alternatively, the RRC reconfiguration information includes the information about the AI-6 interface and the AI connection setup accept information.

1008. The UE sends RRC reconfiguration complete information to the network device.

If the network device sends the RRC reconfiguration information to the UE in step 1007, the UE sends the RRC reconfiguration complete information to the network device in step 1008.

1009. The network device sends radio bearer setup response information to the AI node #1.

If the AI node #1 sends the radio bearer setup request information to the network device in step 1005, the network device sends the radio bearer setup response information to the AI node #1 in step 1009.

Optionally, the method 1000 further includes step 1010.

1010. The AI node #1 and the AI node #2 update a configuration of the AI-6 interface.

That the AI node #1 and the AI node #2 update the configuration of the AI-6 interface indicates that the AI node #1 updates the configuration of the AI-6 interface, for example, updates the resource information of the AI-6 interface, and updates the configuration on a side of the AI node #2. In a possible implementation, the AI node #1 sends an AI connection configuration or an AI connection configuration update to the AI node #2, where the AI connection configuration or the AI connection configuration update includes an updated configuration of the AI-6 interface.

In a possible case, the AI node #1 may update the configuration of the AI-6 interface based on a request of the UE. For example, the UE sends a message to an AI-1 node through an AI-1 interface, where the message is for updating a configuration of an AI-6 interface. After receiving the message, the AI-1 node updates the configuration of the AI-6 interface based on the message.

In another possible case, the AI node #1 may autonomously determine to update the configuration of the AI-6 interface.

1011. Establish the AI-6 interface.

In a possible case, the UE sends the RRC reconfiguration complete information to the network device, the network device sends the radio bearer setup response information to the AI node #1, and the AI node #1 enables the AI-6 interface by default after receiving the radio bearer setup response information, to complete the AI-6 interface between the UE and the AI node #2.

It may be understood that step 1008 and/or step 1009 are/is used as an example for description. In practice, step 1008 and/or step 1009 may not be performed. For example, step 1008 and step 1009 do not need to be performed. To be specific, the network device sends information about the AI-6 interface to the UE, and the UE enables the AI-6 interface by default after receiving the information about the AI-6 interface, to complete the AI-6 interface between the UE and the AI node #2. For another example, step 1008 does not need to be performed. To be specific, after the network device sends the information about the AI-6 interface to the UE, the network device sends the radio bearer setup response information to the AI node #1, the AI node #1 forwards the radio bearer setup response information to the AI node #2, and the AI node #2 enables the AI-6 interface by default after receiving the radio bearer setup response information, to complete the AI-6 interface between the UE and the AI node #2. For another example, step 1009 does not need to be performed. To be specific, after the network device sends the information about the AI-6 interface to the UE by using the RRC reconfiguration information, the UE sends the RRC reconfiguration complete information to the network device, and the network device enables the AI-6 interface by default after receiving the RRC reconfiguration information, to complete the AI-6 interface between the UE and the AI node #2.

After the foregoing steps, the UE sets up an AI connection to the AI node #2, that is, the AI-6 interface between the UE and the AI node #2 is enabled. Therefore, the UE may communicate with the AI node #2 through the AI-6 interface. For example, the UE sends an AI message to the AI node #2 through the AI-6 interface. For another example, the AI node #2 sends an AI message to the UE through the AI-6 interface. For related content of communication between the UE and the AI node #2 through the AI-6 interface, refer to the related descriptions in the method 400. Details are not described herein again.

In the method 1000, an example in which the AI connection between the UE and the AI node #2 is set up via the AI node #1 is mainly used for description. This is not limited herein. For example, the AI connection between the UE and the AI node #2 may alternatively be set up via the network device. For example, the UE may send, to the network device, AI connection setup request information for requesting to establish the AI-6 interface between the UE and the AI node #2. After receiving the AI connection setup request information, the network device selects the AI node #2, and sends the AI connection setup request information to the AI node #2. For another example, the UE selects the AI node #2, and sends, to the network device, AI connection setup request information for requesting to establish the AI-6 interface between the UE and the AI node #2. After receiving the AI connection setup request information, the network device sends the AI connection setup request information to the AI node #2. For a specific implementation, refer to establishment between the UE and the AI node #1 in the method 800. Details are not described herein again.

With reference to FIG. 10, the foregoing describes an example of a scenario in which the UE establishes the AI-6 interface with the AI node #2. The method 1000 may be implemented based on the architecture shown in FIG. 3. Based on the foregoing embodiment, the UE establishes the AI-6 interface with the AI node #2, so that an AI message can be transmitted through the established AI-6 interface, for example, publishing an AI task or receiving an AI task, thereby implementing convergence of a wireless network and AI.

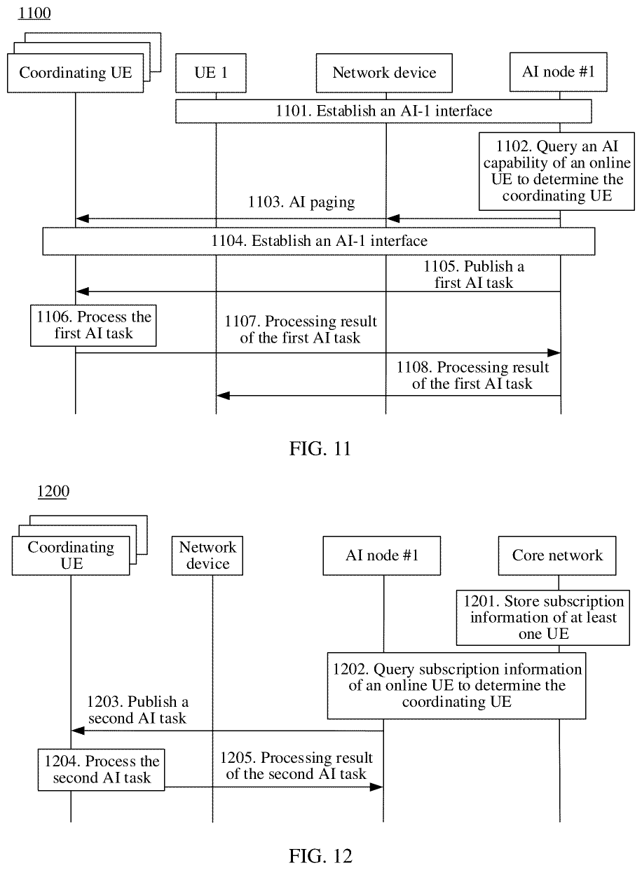

FIG. 11 is a schematic flowchart of a communication method 1100 according to another embodiment of this disclosure. The method 1100 may be for implementing a solution such as the method 400. For example, the method 1100 may be applied to a scenario in which the UE publishes a task to the AI node #1. In an example, the method 1100 may include the following steps.

1101. A UE 1 establishes an AI-1 interface with an AI node #1.

In a possible implementation, the UE 1 establishes the AI-1 interface with the AI node #1, and publishes a first AI task to the AI node #1 in this process. In an example, when sending AI connection setup request information, the UE 1 adds a request type to the AI connection setup request information, where the request type indicates that a purpose of setting up an AI connection is to publish a task.

In another possible implementation, the UE 1 establishes the AI-1 interface with the AI node #1, and publishes a first AI task to the AI node #1 through the established AI-1 interface.

For a manner of establishing the AI-1 interface, refer to the descriptions in the method 800. Details are not described herein again.

1102. The AI node #1 determines a coordinating UE based on an AI capability of an online UE.

There is at least one coordinating UE.

The AI node #1 may determine the coordinating UE based on the AI capability of the online UE, so that the coordinating UE completes the first AI task. For example, the AI capability of the UE includes a first AI task that can be supported by the UE (or a first AI task that can be undertaken, or a first AI task that can be executed). Therefore, the AI node #1 may query the AI capability of the online UE, to determine which UEs can support the first AI task.

For example, it is assumed that the first AI task published by the UE 1 in step 1101 is a model training test task. In this case, the AI node #1 may query the AI capability of the online UE, and determine a coordinating UE that can support the model training test task. In other words, the coordinating UE determined by the AI node #1 can support the model training test task.

Optionally, before step 1102, the method 1100 further includes: The AI node #1 queries a context of the UE 1, and determines priority information of the UE 1. In this way, if a priority of the UE 1 is high, the AI node #1 may preferentially determine a coordinating UE for the first AI task published by the UE 1, so that more UEs can participate in coordinated processing of the first AI task.

In a possible implementation, the AI node #1 and the coordinating UE jointly process the first AI task. For example, the AI node #1 is responsible for processing a part of the first AI task, and the coordinating UE is responsible for processing a remaining part of the first AI task.

In another possible implementation, the coordinating UE processes the first AI task.

If there are at least two coordinating UEs, in an example, the AI node #1 may further determine a task that needs to be processed by each coordinating UE. For example, the AI node #1 divides the first AI task into at least two subtasks, and each coordinating UE may separately process the subtasks of the first AI task, to finally complete the first AI task. Alternatively, the AI node #1 may directly publish the first AI task to the coordinating UEs.

1103. The AI node #1 sends AI paging to the coordinating UE.

After determining the coordinating UE, the AI node #1 may send the AI paging to the coordinating UE, to trigger the coordinating UE to initiate AI connection setup request information, to establish an AI-1 interface between the coordinating UE and the AI node #1. It may be understood that the AI paging is merely a possible naming manner, and naming of the AI paging does not limit the protection scope of this disclosure.

1104. The AI node #1 establishes an AI-1 interface with the coordinating UE.

For a manner of establishing the AI-1 interface, refer to the descriptions in the method 800. Details are not described herein again.

It may be understood that, if the AI-1 interface has been established between the AI node #1 and the coordinating UE, steps 1103 and 1104 may not be performed. In other words, after determining the coordinating UE, the AI node #1 directly publishes the first AI task to the coordinating UE.

1105. The AI node #1 publishes the first AI task to the coordinating UE.

After establishing the AI-1 interface with the coordinating UE, the AI node #1 may publish an AI task to the coordinating UE through a corresponding AI-1 interface. For example, the AI node #1 publishes the first AI task to the coordinating UE, and the first AI task is the same as the first AI task published by the UE 1 in step 1101. It may be understood that FIG. 11 shows only a case in which the coordinating UE processes the first AI task. For example, as described above, if there are at least two coordinating UEs, alternatively, the AI node #1 may divide the first AI task into at least two subtasks, and each coordinating UE may separately process the subtasks of the first AI task, to finally complete the first AI task. For another example, the AI node #1 processes a first subtask of the first AI task, the AI node #1 publishes a second subtask of the first AI task to the coordinating UE, and the coordinating UE processes the second subtask of the first AI task.

1106. The coordinating UE processes the first AI task.

1107. The coordinating UE sends a processing result of the first AI task to the AI node #1.

After completing the first AI task, the coordinating UE sends the processing result of the first AI task to the AI node #1.

Further, optionally, if the first AI task has a corresponding preset condition, the processing result of the first AI task may be sent to the AI node #1 when the preset condition is met. For details, refer to the related descriptions in the method 400. Details are not described herein again.

1108. The AI node #1 sends the processing result of the first AI task to the UE 1.

After receiving the processing result of the first AI task sent by the coordinating UE, the AI node #1 may directly forward the processing result of the first AI task to the UE 1. Alternatively, if the AI node #1 receives at least two processing results of the first AI task, the AI node #1 may select one of the processing results and send the processing result to the UE 1, or may further process the at least two received processing results of the first AI task and then send a processing result to the UE 1. This is not limited.

Optionally, the AI node #1 updates priority information of the coordinating UE in a context of the coordinating UE. In this disclosure, priority information of a UE may be dynamically updated based on a historical response status of the UE.

It may be understood that the method 1100 is mainly described by using an example in which the coordinating UE processes the first AI task. It may be understood that, in actual communication, after receiving the first AI task published by the UE 1, the AI node #1 may process the first AI task by itself, and the AI node #1 may send a processing result of the first AI task to the UE 1 after the AI node #1 processes the first AI task. Alternatively, after receiving the first AI task published by the UE 1, the AI node #1 may indicate an AI node #2 to process the first AI task (including a complete task or a subtask). After the AI node #2 processes the first AI task, the AI node #2 may send a processing result of the first AI task to the UE 1, or the AI node #2 may send the processing result of the first AI task to the AI node #1, and the AI node #1 sends the processing result of the first AI task to the UE 1. Alternatively, the AI node #1 may process a part of the first AI task, and indicate a remaining task to the AI node #2 and/or the coordinating UE for processing. It may be understood that a quantity of AI nodes is not limited in this disclosure, and an AI node #3 and an AI node #4 may further coordinate to complete the first AI task.

It may be further understood that the method 1100 is mainly described by using an example in which the coordinating UE sends the processing result of the first AI task to the AI node #1, and then the AI node #1 sends the processing result of the first AI task to the UE 1. For example, the coordinating UE may alternatively directly send the processing result of the first AI task to the UE 1.

With reference to FIG. 11, the foregoing describes an example of a scenario in which the UE publishes an AI task to the AI node #1. Based on the foregoing embodiment, the UE establishes an AI-1 interface with the AI node #1, so that the UE may publish an AI task to the AI node #1 through the established AI-1 interface. In addition, if the AI node #1 cannot process the AI task or the AI node #1 needs assistance of another AI node or a coordinating UE, the AI node #1 may also publish the AI task to the another AI node or another UE, so that the another AI node or the another UE processes the AI task. In this way, the AI task can be completed by using an idle computing resource (for example, a computing power of the coordinating UE), thereby reducing a load and energy consumption of an AI network.

FIG. 12 is a schematic flowchart of a communication method 1200 according to another embodiment of this disclosure. The method 1200 may be for implementing a solution such as the method 400. For example, the method 1200 may be applied to a scenario in which the AI node #1 publishes a task to the UE. In an example, the method 1200 may include the following steps. 1201. A core network stores subscription information of at least one UE.

The subscription information includes an AI capability of the UE. The AI capability of the UE may include, for example, at least one of the following: a priority of the UE, a maximum computing power supported by the UE, an AI task type supported by the UE, a hardware capability of the UE, and a security requirement of the UE.

1202. The AI node #1 queries subscription information of an online UE from the core network to determine a coordinating UE.

There is at least one coordinating UE.

In step 1202, the AI node #1 may query the subscription information of the online UE from the core network, to obtain the AI capability of the online UE. The AI node #1 determines, based on the AI capability of the online UE, at least one UE that is to process a second AI task (for differentiation, the at least one UE that processes the second AI task is referred to as a coordinating UE). For example, it is assumed that the second AI task to be published by the AI node #1 is a model test task, the AI node #1 may determine, based on the AI capability of the online UE, a UE that can support the model test task. In other words, the coordinating UE determined by the AI node #1 can support the model test task.

1203. The AI node #1 publishes the second AI task to the coordinating UE.

For example, the AI node #1 publishes the second AI task to the coordinating UE through an AI-1 interface. It may be understood that, if the AI-1 interface has not been established between the AI node #1 and the coordinating UE, before step 1203, the AI node #1 may first establish the AI-1 interface with the coordinating UE, and then the AI node #1 publishes the second AI task to the coordinating UE through the AI-1 interface.

In an example, if there are at least two coordinating UEs, the AI node #1 may alternatively divide the second AI task into at least two subtasks, and each coordinating UE may separately process the subtasks of the second AI task, to finally complete the second AI task. For another example, the AI node #1 processes a first subtask of the second AI task, the AI node #1 publishes a second subtask of the second AI task to the coordinating UE, and the coordinating UE processes the second subtask of the second AI task.

The following provides a specific example with reference to Table 3.

TABLE 3

| Second AI task | Description | Parameter | Preset condition | Reported parameter |
|---|---|---|---|---|
| AI-M1 | Model | Model | Event: Performance | Location, |
| | failure test | parameter | degrades to a | timestamp, and |
| | | | threshold. | error amount |
| AI-M2 | Model | Model | Periodic | Location, |
| | performance | parameter | | timestamp, and |
| | test | | | error amount |
| AI-M3 | Model | Model | Periodic | Location, |
| | training test | parameter | | timestamp, and |
| | | | | convergence time |
| AI-M4 | Data | Data type | Event: (1) Move to | Location, |
| | collection | | a specific area. (2) | timestamp, and data |
| | | | Model performance | sample |
| | | | degrades. | |
| . . . | | | | |

Assuming that the second AI task published by the AI node #1 is a model test task (for example, a model failure test task, a model performance test task, or a model training test task), a task configured by the AI node #1 may include a parameter of a model that needs to be tested, a preset condition, and a measurement reporting parameter.

(1) The parameter of the model that needs to be tested is for describing a to-be-tested model.

(2) The preset condition indicates a trigger condition for measurement reporting. For example, if the second AI task is a model failure test task, the preset condition is that model performance degrades to a threshold. To be specific, when the model performance degrades to the threshold, a processing result of the model failure test task is reported. For another example, if the second AI task is a model performance test task, the preset condition is periodic reporting. To be specific, a processing result of the model performance test task is periodically reported (or reported at intervals). For another example, if the second AI task is a model training test task, the preset condition is periodic reporting. To be specific, a processing result of the model performance test task is periodically reported (or reported at intervals).

(3) The measurement report parameter indicates a task processing result. For example, if the second AI task is a model failure test task, the measurement reporting parameter may include a model failure location, a model error amount, and a model timestamp. For another example, if the second AI task is a model performance test task, the measurement reporting parameter may include a model performance test location, a model error amount, and a model timestamp. For another example, if the second AI task is a model training test task, the measurement reporting parameter may include a model failure location, a model error amount, and model training convergence time.

1204. The coordinating UE processes the second AI task.

1205. The coordinating UE sends a processing result of the second AI task to the AI node #1.

Assuming that the second AI task published by the AI node #1 is a model test task (for example, the model failure test task in Table 3, the model performance test task in Table 3, or the model training test task in Table 3), the coordinating UE processes the model test task. If the model test task corresponds to a corresponding preset condition, after executing the model test task, the coordinating UE may first cache a test result locally, and report a processing result of the model test task to the AI node #1 through an AI-1 interface when the preset condition is met.

With reference to FIG. 12, the foregoing describes an example of a scenario in which the AI node #1 publishes an AI task to the UE. Based on the foregoing embodiment, the UE establishes the AI-1 interface with the AI node #1, so that the AI node #1 can publish an AI task to the UE through the established AI-1 interface. In this way, the AI task can be completed by using an idle computing resource (for example, a computing power of the UE), thereby reducing a load and energy consumption of an AI network.

It may be understood that the examples in FIG. 8 to FIG. 12 in embodiments of this disclosure are merely intended to help a person skilled in the art understand embodiments of this disclosure, but are not intended to limit embodiments of this disclosure to specific scenarios in the examples. A person skilled in the art may apparently make various equivalent modifications or changes based on the examples shown in FIG. 8 to FIG. 12, and such modifications or changes also fall within the scope of embodiments of this disclosure. For example, the AI node #1 in FIG. 11 or FIG. 12 may alternatively be an AI node #2, and correspondingly, the AI-1 interface is replaced with an AI-6 interface.

It may be further understood that, in embodiments of this disclosure, the “AI connection” and the “AI interface” may be used interchangeably. For example, “the terminal device communicates with the AI node #1 through an AI connection” may alternatively be “the terminal device communicates with the AI node #1 through an AI-1 interface”. For another example, “the terminal device communicates with the AI node #2 through an AI connection” may alternatively be “the terminal device communicates with the AI node #2 through an AI-6 interface”.

It may be further understood that, in embodiments of this disclosure, an example in which the AI node #1 manages the AI-1 interface and the AI-6 interface is mainly used for description. In an example, the AI node #1 manages the AI-1 interface, and the AI node #2 manages the AI-6 interface. In another example, another apparatus manages the AI-1 interface and the AI-6 interface. For example, another apparatus configures, updates, and releases a resource that is for the AI-1 interface, and notifies the AI node #1 of the resource. For another example, another apparatus configures, updates, and releases a resource that is for the AI-6 interface, and notifies the AI node #2 of the resource; or the another apparatus first notifies the AI node #1, and then the AI node #1 notifies the AI node #2 of the resource.

It may be further understood that, in some embodiments of this disclosure, processing an AI task is mentioned for a plurality of times. It may be understood that processing an AI task may alternatively be executing an AI task.

It may be further understood that in embodiments of this disclosure, an example in which an AI task is published between an AI node and UE is mainly used for description. For example, an AI task may also be published between AI nodes. For another example, an AI task may also be published between UEs.

It may be further understood that, in embodiments of this disclosure, for example, A publishes an AI task to B. The AI task published by A to B may be the entire AI task, or may be a part of the AI task. Correspondingly, based on an AI task publishing status, that B completes the AI task (or that B processes the AI task) includes: completing the entire AI task, or completing a part of the AI task.

It may be further understood that, in embodiments of this disclosure, setup of the AI connection may be initiated by the UE, or may be initiated by the AI node.

It may be further understood that, in embodiments of this disclosure, the AI node may be a dedicated function node, or may be a network device (for example, a base station) or a terminal device having a corresponding function.

It may be further understood that naming of some message or information names in embodiments of this disclosure does not limit the protection scope of embodiments of this disclosure. An example in which A sends a message to B is used, and any message that can be used between A and B is applicable to embodiments of this disclosure.

It may be further understood that, in some of the foregoing embodiments, sending a message is mentioned for a plurality of times. For example, A sends a message to B. That A sends a message to B may include that A directly sends a message to B, or may include that A sends a message to B via another apparatus. This is not limited.

It may be further understood that some optional features in embodiments of this disclosure may not depend on another feature in some scenarios, or may be combined with another feature in some scenarios. This is not limited.

It may be further understood that, solutions in embodiments of this disclosure may be appropriately combined for use, and explanations or descriptions of terms in embodiments may be mutually referenced or explained in embodiments. This is not limited.

It may be further understood that, in the foregoing method embodiments, methods and operations implemented by a device (for example, a terminal device, an AI node, or a network device) may also be implemented by a component (for example, a chip or a circuit) of the device.

Corresponding to the methods provided in the foregoing method embodiments, embodiments of this disclosure further provide a corresponding apparatus. The apparatus includes corresponding modules configured to perform the foregoing method embodiments. The module may be software, hardware, or a combination of software and hardware. It may be understood that the technical features described in the method embodiments are also applicable to the following apparatus embodiments.

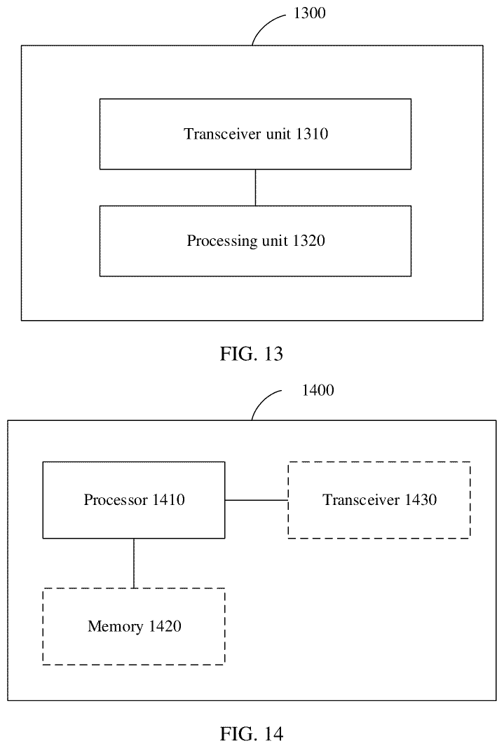

FIG. 13 is a block schematic of a communication apparatus 1300 according to an embodiment of this disclosure. The apparatus 1300 includes a transceiver unit 1310 and a processing unit 1320. The transceiver unit 1310 may be configured to implement a corresponding communication function. The transceiver unit 1310 may also be referred to as a communication interface or a communication unit. The processing unit 1320 may be configured to process data.

In a design, the apparatus 1300 is configured to perform the steps or procedures performed by the communication apparatus in the embodiment shown in FIG. 4, the steps or procedures performed by the UE in the embodiments shown in FIG. 8 and FIG. 10, the steps or procedures performed by the UE 1 in the embodiment shown in FIG. 11, and the steps or procedures performed by the coordinating UE in the embodiment shown in FIG. 12.

In a possible implementation, the transceiver unit 1310 is configured to receive information about an AI connection, where the information about the AI connection includes at least one of the following configured for the AI connection: a model, a dataset, and a computing resource. The processing unit 1320 is configured to set up the AI connection to an AI node based on the information about the AI connection.

In an example, the transceiver unit 1310 is further configured to send an AI message to the AI node through the AI connection, and/or receive an AI message from the AI node through the AI connection, where the AI message indicates at least one of the following information: an encryption mode used for the AI message, a compression mode used for the AI message, a message type of the AI message, control information or data carried in the AI message, a verification code for performing integrity verification on the AI message, or content carried in the AI message.

In another example, the transceiver unit 1310 is further configured to receive information about an updated AI connection through the AI connection.

In another example, the processing unit 1320 is configured to perform at least one of the following: if the information about the AI connection includes the model, processing the model; if the information about the AI connection includes the dataset, performing measurement based on the dataset; and if the information about the AI connection includes the computing resource, using the computing resource to execute an AI task.

In another example, the transceiver unit 1310 is further configured to: publish a first AI task to the AI node through the AI connection; and/or receive a second AI task from the AI node through the AI connection.

In another example, the transceiver unit 1310 is specifically configured to publish the first AI task to the AI node through the AI connection, to publish the first AI task to another communication apparatus via the AI node.

In another example, the transceiver unit 1310 is further configured to: when a preset condition is met, send a processing result of the second AI task.

In another example, the second AI task includes indication information of the preset condition.

In another example, the transceiver unit 1310 is further configured to: send a request message to the AI node, where the request message is for requesting to set up the AI connection; or receive indication information from the AI node, where the indication information is for triggering the communication apparatus to set up the AI connection to the AI node.

In another example, the request message further includes indication information of a request type, the request type indicates a purpose of requesting to set up the AI connection, and the dataset is determined based on the request type.

In another example, the information about the AI connection further includes at least one of the following: an identifier of the AI connection and information about a radio bearer associated with the AI connection.

In another example, the AI node is deployed on any one of the following: a network device and a terminal device.

In another design, the apparatus 1300 is configured to perform the steps or the procedures performed by the AI node in the embodiment shown in FIG. 4, the steps or the procedures performed by the AI node #1 in the embodiment shown in FIG. 8, the steps or the procedures performed by the AI node #1 and/or the AI node #2 in the embodiment shown in FIG. 10, and the steps or the procedures performed by the AI node #1 in the embodiments shown in FIG. 11 and FIG. 12.

In a possible implementation, the transceiver unit 1310 is configured to send information about an AI connection, where the information about the AI connection includes at least one of the following configured for the AI connection: a model, a dataset, and a computing resource. The processing unit 1320 is configured to set up the AI connection to the communication apparatus based on the information about the AI connection.

In an example, the transceiver unit 1310 is further configured to send an AI message to the communication apparatus through the AI connection, and/or receive an AI message from the communication apparatus through the AI connection, where the AI message indicates at least one of the following information: an encryption mode used for the AI message, a compression mode used for the AI message, a message type of the AI message, control information or data carried in the AI message, a verification code for performing integrity verification on the AI message, or content carried in the AI message.

In another example, the transceiver unit 1310 is further configured to send information about an updated AI connection to the communication apparatus through the AI connection.

In another example, the processing unit 1320 is configured to perform at least one of the following: if the information about the AI connection includes the model, processing, based on the model, data sent by the communication apparatus; if the information about the AI connection includes the dataset, managing the dataset; and if the information about the AI connection includes the computing resource, using the computing resource to execute an AI task.

In another example, the processing unit 1320 is further configured to determine the information about the AI connection based on an AI capability of the communication apparatus.

In another example, the transceiver unit 1310 is further configured to: receive, through an AI connection between the AI node and each of the at least one communication apparatus, a first AI task published by the at least one communication apparatus; and/or publish a second AI task to the at least one communication apparatus through the AI connection between the AI node and each of the at least one communication apparatus, where the at least one communication apparatus includes the communication apparatus.

In another example, the transceiver unit 1310 is specifically configured to publish the second AI task to the communication apparatus through the AI connection between the AI node and the communication apparatus, to publish the second AI task to another communication apparatus via the communication apparatus.

In another example, the transceiver unit 1310 is further configured to: when a preset condition is met, send a processing result of the first AI task to the at least one communication apparatus through the AI connection between the AI node and each of the at least one communication apparatus.

In another example, the first AI task includes indication information of the preset condition.

In another example, the transceiver unit 1310 is further configured to: receive a request message from the communication apparatus, where the request message is for requesting to set up the AI connection; or send indication information to the communication apparatus, where the indication information is for triggering the communication apparatus to set up the AI connection to the AI node.

In another example, the request message further includes indication information of a request type, the request type indicates a purpose of requesting to set up the AI connection, and the dataset is determined based on the request type.

In another example, the information about the AI connection further includes at least one of the following: an identifier of the AI connection and information about a radio bearer associated with the AI connection.

In another example, the apparatus 1300 includes a first AI node and a second AI node. The first AI node and/or the second AI node meet/meets any one of the following: The first AI node is configured to transmit signaling, and the second AI node is configured to process an AI task; the second AI node is configured to process an AI operation indicated by the first AI node; the first AI node is configured to process a first-type AI task, the second AI node is configured to process a second-type AI task, and the first-type AI task is not completely the same as the second-type AI task; and the second AI node is configured to store and/or send a processing result of the AI task.

In another example, the transceiver unit 1310 is further configured to send notification information to the second AI node, where the notification information is for notifying the second AI node of at least one of the following: executing the AI task, saving the processing result of the AI task, and sending the processing result of the AI task.

In another example, the AI node is deployed on any one of the following: a network device and a terminal device.

In another example, the AI node is deployed on the network device, and the processing unit 1320 is further configured to determine, based on at least one of the following: the model, the dataset, and the computing resource, information about a radio bearer associated with the AI connection.

It should be understood that, a specific process in which each unit performs the foregoing corresponding steps has been described in detail in the foregoing method embodiments. For brevity, details are not described herein again.

It should be understood that the apparatus 1300 herein is embodied in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function.

For example, a product implementation form of the apparatus 1300 provided in this embodiment of this application is program code that can be run on a computer.

For example, the apparatus 1300 provided in this embodiment of this application may be a communication device, or may be a chip, a chip system (for example, a system on chip (SoC)), or a circuit used in the communication device. When the apparatus 1300 is the communication device, the transceiver unit 1310 may be a transceiver or an input/output interface, and the processing unit 1320 may be a processor. When the apparatus 1300 is the chip, the chip system, or the circuit used in the communication device, the transceiver unit 1310 may be an input/output interface, an interface circuit, an output circuit, an input circuit, a pin, a related circuit, or the like on the chip, the chip system, or the circuit; and the processing unit 1320 may be a processor, a processing circuit, a logic circuit, or the like.

In addition, the transceiver unit 1310 may alternatively be a transceiver circuit (for example, the transceiver circuit may include a receiver circuit and a transmitter circuit), and the processing unit may be a processing circuit.

FIG. 14 is a block schematic of a communication apparatus 1400 according to an embodiment of this application. The apparatus 1400 includes a processor 1410, and the processor 1410 is coupled to a memory 1420. Optionally, the apparatus further includes the memory 1420, configured to store a computer program or instructions and/or data. The processor 1410 is configured to execute the computer program or the instructions stored in the memory 1420, or read the data stored in the memory 1420, to perform the methods in the foregoing method embodiments.

Optionally, there are one or more processors 1410.

Optionally, there are one or more memories 1420.

Optionally, the memory 1420 and the processor 1410 are integrated together or disposed separately.

Optionally, as shown in FIG. 14, the apparatus 1400 further includes a transceiver 1430. The transceiver 1430 is configured to receive a signal and/or send a signal. For example, the processor 1410 is configured to control the transceiver 1430 to receive a signal and/or send a signal.

In a solution, the apparatus 1400 is configured to implement operations performed by a communication apparatus in the foregoing method embodiments.

For example, the processor 1410 is configured to execute the computer program or the instructions stored in the memory 1420, to implement related operations of a communication apparatus in the foregoing method embodiments, for example, the method performed by a communication apparatus in the embodiment shown in FIG. 4, the method performed by the UE in the embodiments shown in FIG. 8 and FIG. 10, the method performed by the UE 1 in the embodiment shown in FIG. 11, or the method performed by the coordinating UE in the embodiment shown in FIG. 12.

In another solution, the apparatus 1400 is configured to implement operations performed by an AI node in the foregoing method embodiments.

For example, the processor 1410 is configured to execute the computer program or instructions stored in the memory 1420, to implement related operations of the AI node in the foregoing method embodiments, for example, the method performed by the AI node in the embodiment shown in FIG. 4, the method performed by the AI node #1 in the embodiment shown in FIG. 8, the method performed by the AI node #1 and/or the AI node #2 in the embodiment shown in FIG. 10, or the method performed by the AI node #1 in the embodiments shown in FIG. 11 and FIG. 12.

In an implementation process, the steps of the foregoing methods may be implemented by using an integrated logical circuit of hardware in the processor 1410, or instructions in a form of software. The method disclosed with reference to embodiments of this application may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory 1420, and the processor 1410 reads information in the memory 1420 and implements the steps of the foregoing methods in combination with hardware of the processor. To avoid repetition, details are not described herein again.

It should be understood that, in embodiments of this application, the processor may be one or more integrated circuits, and is configured to execute a related program, to perform the method embodiments of this application.

A processor (for example, the processor 1410) may include one or more processors and be implemented as a combination of computing devices. The processor may include one or more of the following: a microprocessor, a microcontroller, a digital signal processor (DSP), a digital signal processing device (DSPD), an application-specific integrated circuit (ASIC), a field programmable gate array (FPGA), a programmable logic device (PLD), gating logic, transistor logic, a discrete hardware circuit, a processing circuit, or another proper combination of hardware and firmware and/or hardware and software, and is configured to perform various functions described in this disclosure. The processor may be a general-purpose processor or a special-purpose processor. For example, the processor 1410 may be a baseband processor or a central processing unit. The baseband processor may be configured to process a communication protocol and communication data. The central processing unit may be configured to enable the apparatus to execute a software program and process data in the software program. A part of the processor may further include a non-volatile random access memory. For example, the processor may further store information of a device type.

The program in this application represents software in a broad sense. A non-limitative example of the software includes program code, a program, a subprogram, instructions, an instruction set, code, a code segment, a software module, an application program, a software application program, or the like. The program may be run in a processor and/or a computer, so that the apparatus performs various functions and/or processes described in this application.

The memory (for example, the memory 1420) may store data required by the processor (for example, the processor 1410) during software execution. The memory may be implemented by using any suitable storage technology. For example, the memory may be any available storage medium that can be accessed by a processor and/or a computer. Non-limiting examples of the storage medium include: a random access memory (RAM), a read-only memory (ROM), an electrically erasable programmable read-only memory (EEPROM), a compact disc read-only memory (CD-ROM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM), a removable medium, an optical disc memory, a magnetic disk storage medium, a magnetic storage device, a flash memory, a register, a state memory, a remote mounted memory, a local or remote storage component, or any other medium capable of carrying or storing software, data, or information and accessible by a processor/computer. It should be noted that the memory described in this specification aims to include but is not limited to these memories and any memory of another appropriate type.

The memory (for example, the memory 1420) and the processor (for example, the processor 1410) may be separately disposed or integrated together. The memory may be configured to connect to the processor, so that the processor can read information from the memory, and store information in and/or write information into the memory. The memory may be integrated into the processor. The memory and the processor may be disposed in an integrated circuit (where for example, the integrated circuit may be disposed in a UE, a BS, or another network node).

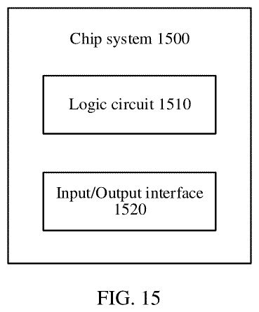

FIG. 15 is a block schematic of a chip system 1500 according to an embodiment of this application. The chip system 1500 (or may be referred to as a processing system) includes a logic circuit 1510 and an input/output interface 1520.

The logic circuit 1510 may be a processing circuit in the chip system 1500. The logic circuit 1510 may be coupled and connected to a storage unit, and invoke instructions in the storage unit, so that the chip system 1500 can implement the methods and functions in embodiments of this application. The input/output interface 1520 may be an input/output circuit in the chip system 1500, and outputs information processed by the chip system 1500, or inputs to-be-processed data or signaling information to the chip system 1500 for processing.

In a solution, the chip system 1500 is configured to implement operations performed by a communication apparatus in the foregoing method embodiments.

For example, the logic circuit 1510 is configured to implement a processing related operation performed by a communication apparatus in the foregoing method embodiments, for example, a processing related operation performed by a communication apparatus in the embodiment shown in FIG. 4, a processing related operation performed by the UE in the embodiments shown in FIG. 8 and FIG. 10, a processing related operation performed by the UE 1 in the embodiment shown in FIG. 11, or a processing related operation performed by the coordinating UE in the embodiment shown in FIG. 12. The input/output interface 1520 is configured to implement sending and/or receiving related operations performed by a communication apparatus in the foregoing method embodiments, for example, sending and/or receiving related operations performed by a communication apparatus in the embodiment shown in FIG. 4, sending and/or receiving related operations performed by the UE in the embodiments shown in FIG. 8 and FIG. 10, sending and/or receiving related operations performed by the UE 1 in the embodiment shown in FIG. 11, or sending and/or receiving related operations performed by the coordinating UE in the embodiment shown in FIG. 12.

In another solution, the chip system 1500 is configured to implement operations performed by the AI node in the foregoing method embodiments.

For example, the logic circuit 1510 is configured to implement a processing related operation performed by the AI node in the foregoing method embodiments, for example, a processing related operation performed by the AI node in the embodiment shown in FIG. 4, a processing related operation performed by the AI node #1 in the embodiment shown in FIG. 8, a processing related operation performed by the AI node #1 and/or the AI node #2 in the embodiment shown in FIG. 10, or a processing related operation performed by the AI node #1 in the embodiments shown in FIG. 11 and FIG. 12. The input/output interface 1520 is configured to implement sending and/or receiving related operations performed by the AI node in the foregoing method embodiments, for example, sending and/or receiving related operations performed by the AI node in the embodiment shown in FIG. 4, sending and/or receiving related operations performed by the AI node #1 in the embodiment shown in FIG. 8, sending and/or receiving related operations performed by the AI node #1 and/or the AI node #2 in the embodiment shown in FIG. 10, or sending and/or receiving related operations performed by the AI node #1 in the embodiments shown in FIG. 11 and FIG. 12.

An embodiment of this application further provides a computer-readable storage medium, where the computer-readable storage medium stores computer instructions for implementing the method performed by the communication apparatus or the AI node in the foregoing method embodiments.

An embodiment of this application further provides a computer program product including instructions. When the instructions are executed by a computer, the method performed by the communication apparatus or the AI node in the foregoing method embodiments is implemented.

An embodiment of this application further provides a communication system. The communication system includes the communication apparatus and the AI node in the foregoing embodiments.

For explanations and beneficial effects of related content of any one of the apparatuses provided above, refer to a corresponding method embodiment provided above. Details are not described herein again.

In the several embodiments provided in this application, it should be understood that the disclosed apparatus and method may be implemented in other manners. For example, the foregoing apparatus embodiments are only examples. For example, division into the foregoing units is only logical function division, and may be another division manner in an actual implementation. For example, a plurality of units or components may be combined or integrated into another system, or some features may be ignored or not performed. In addition, the displayed or discussed mutual couplings, direct couplings, or communication connections may be implemented through some interfaces. Indirect couplings or communication connections between the apparatuses or units may be implemented in an electrical form, a mechanical form, or another form.

The foregoing units described as separate parts may or may not be physically separate, and parts displayed as units may or may not be physical units, may be located in one position, or may be distributed on a plurality of network units. Some or all of the units may be selected based on actual requirements to implement the solutions provided in this application.

In addition, functional units in embodiments of this application may be integrated into one unit, each of the units may exist alone physically, or two or more units may be integrated into one unit.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

When software is used to implement the embodiments, all or a part of the embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or other programmable apparatuses. For example, the computer may be a personal computer, a server, or a network device. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. For the computer-readable storage medium, refer to the foregoing descriptions.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
receiving information about an artificial intelligence (AI) connection, wherein the information about the AI connection comprises at least one of:
a model configured for the AI connection, a dataset configured for the AI connection, or a computing resource configured for the AI connection; and
setting up the AI connection to a node based on the information about the AI connection.

2. The method according to claim 1, further comprising:
communicating an AI message to the node by the AI connection, wherein the AI message usable to indicate at least one of:
an encryption mode usable for the AI message,
a compression mode usable for the AI message,
a message type of the AI message,
control information or data included in the AI message,
a verification code usable for performing integrity verification on the AI message, or
content included in the AI message.

3. The method according to claim 1, further comprising:
receiving information about an updated AI connection by the AI connection.

4. The method according to claim 1, wherein the information about the connection further comprises:
the model, and the method further comprises processing the model;
the dataset, and the method further comprises performing a measurement based on the dataset; and
the computing resource, and the method further comprises using the computing resource to execute an AI task.

5. The method according to claim 1, further comprising:
publishing a first AI task to the node by the AI connection.

6. The method according to claim 1, further comprising:
receiving a second AI task from the node by the AI connection.

7. The method according to claim 6, further comprising:
sending a processing result of the second AI task in response to a preset condition being met.

8. The method according to claim 7, wherein the second AI task comprises:
indication information associated with the preset condition.

9. The method according to claim 1, further comprising:
sending a request message to the node, wherein the request message is usable for requesting to set up the AI connection.

10. The method according to claim 9, wherein the request message further comprises:
indication information of a request type, the request type is usable to indicate a purpose of requesting to set up the AI connection, and the dataset is determined based on the request type.

11. The method according to claim 1, further comprising:
receiving indication information from the node, wherein the indication information is usable for triggering to set up the AI connection to the node.

12. The method according to claim 1, wherein the information about the AI connection further comprises at least one of:
an identifier of the AI connection, or
information about a radio bearer associated with the AI connection.

13. The method according to claim 1, wherein the node is comprised in one of:
a network device or a terminal device.

14. A communication method, comprising:
sending information about an artificial intelligence (AI) connection, wherein the information about the AI connection comprises at least one of:
a model configured for the AI connection, a dataset configured for the AI connection, or a computing resource configured for the AI connection; and
setting up the AI connection to a communication apparatus based on the information about the AI connection.

15. The method according to claim 14, further comprising:
communicating an AI message with the communication apparatus through the AI connection, wherein the AI message indicates one or more of:
an encryption mode usable for the AI message,
a compression mode usable for the AI message,
a message type of the AI message,
control information or data included in the AI message,
a verification code usable for performing integrity verification on the AI message, or
content included in the AI message.

16. The method according to claim 14, further comprising:
sending information about an updated AI connection to the communication apparatus by the AI connection.

17. The method according to claim 14, wherein the information about the connection further comprises:
the model, and the method further comprises processing, based on the model, data sent by the communication apparatus;
the dataset, and the method further comprises managing the dataset; and
the computing resource, and the method further comprises using the computing resource to execute an AI task.

18. The method according to claim 14, further comprising:
determining the information about the AI connection based on an AI capability of the communication apparatus.

19. The method according to claim 14, further comprising:
receiving, by an AI connection, a first AI task published by the communication apparatus.

20. The method according to claim 14, further comprising:
publishing a second AI task to the communication apparatus by the AI connection.

21. The method according to claim 19, further comprising:
sending a processing result of the first AI task to the at least one communication apparatus by the AI connection between the AI node and the communication apparatus in response to a preset condition being met.

22. The method according to claim 21, wherein the first AI task comprises:
indication information of the preset condition.

23. The method according to claim 14, further comprising:
receiving a request message from the communication apparatus, wherein the request message is usable for requesting to set up the AI connection.

24. The method according to claim 23, wherein the request message further comprises:
indication information of a request type, the request type is usable to indicate a purpose of requesting to set up the AI connection, and the dataset is determined based on the request type.

25. The method according to claim 14, further comprising:
sending indication information to the communication apparatus, wherein the indication information is usable for triggering to set up the AI connection to the AI node.

26. The method according to claim 14, wherein the information about the AI connection further comprises at least one of:
an identifier of the AI connection, or
information about a radio bearer associated with the AI connection.

27. The method according to claim 14, wherein the AI node is comprised in one of:
a network device or a terminal device.

28. The method according to claim 14, wherein
the AI node is comprised in a network side apparatus, and
the method further comprises:
determining information about a radio bearer associated with the AI connection based on at least one of:
the model,
the dataset or
the computing resource.

29. A communication apparatus, comprising:
a non-transitory memory configured to store instructions; and
a processor configured to execute the instructions to thereby cause the communication apparatus to:
receive information about an artificial intelligence (AI) connection, wherein the information about the AI connection comprises at least one of:
a model configured for the AI connection, a dataset configured for the AI connection, or a computing resource configured for the AI connection; and
set up the AI connection to a node based on the information about the AI connection.

30. A non-transitory computer-readable storage medium, wherein the non-transitory computer-readable storage medium is configured to store instructions, and in response to the instructions being executed by a processor, thereby causes the processor to perform:
receive information about an artificial intelligence (AI) connection, wherein the information about the AI connection comprises at least one of:
a model configured for the AI connection, a dataset configured for the AI connection, or a computing resource configured for the AI connection; and
set up the AI connection to a node based on the information about the AI connection.
